(19) United States
(12) Patent Application Publication
(10) Pub. No.: US 2026/0213241 A1
(43) Pub. Date: Jul. 23, 2026

(54) Electrolyte Compositions Comprising Distinct Redox-Active Species And Uses Thereof

(71) Applicant: CMBlu Energy AG, Alzenau (DE)

(72) Inventors: Peter GEIGLE, Alzenau (DE); Jan HARTWIG, Alzenau (DE); Doris NEUMANN, Offenbach (DE); Eduard BAAL, Offenbach (DE); Evgeny LARIONOV, Hanau (DE); Isabel SCHEIBEL, Alzenau (DE); Nils WEDLER, Ladenburg (DE); Christian SCHNEIDER, Aschaffenburg (DE)

(21) Appl. No.: 19/412,996

(22) Filed: Dec. 9, 2025

Related U.S. Application Data
(63) Continuation of application No. 17/799,877, filed on Feb. 22, 2021, now abandoned.

(30) Foreign Application Priority Data
Feb. 20, 2020 (WO) PCT/EP2020/054564

(51) Int. Cl. H01M 8/18; H01M 50/46

(52) U.S. Cl. CPC H01M 8/18; H01M 50/46

(57) ABSTRACT

The present invention relates to electrolyte compositions comprising distinct redox-active compounds, namely, a redox-active compound, which is phenazine or a phenazine derivative, and a distinct redox-active compound, which is not phenazine or a phenazine derivative. The present invention also relates to the use of such electrolyte compositions as redox flow battery electrolytes. Accordingly, the invention further provides a redox flow battery comprising said compositions.

This application is a continuation of U.S. patent application Ser. No. 17/799,877, filed Dec. 28, 2022, which is a U.S. National Phase application under 35 U.S.C. § 371 of PCT/EP2021/054296, filed Feb. 22, 2021, which claims foreign priority to PCT/EP2020/054564, filed Feb. 20, 2020, the specifications of which are hereby incorporated by reference in their entireties into the instant application.

The present invention relates to the field of electrolyte compositions for redox flow batteries. In particular, the present invention provides an electrolyte composition comprising two distinct redox-active species, namely, (i) phenazine or a phenazine derivative and (ii) a redox-active species, which is not phenazine or a phenazine derivative. The present invention also relates to the use of the electrolyte compositions in redox-flow batteries, in particular as negolytes.

Progressive depletion of fossil fuel reserves and concerns resulting from its environmental consequences as the main energy sources have led to an increasing prominence of renewable energy systems, e.g., solar- and wind-based systems. The intermittent nature of renewable energy sources, however, makes it difficult to fully integrate these energy sources into electrical grids, resulting in the danger of power outages or negative power prices (B. Dunn, H. Kamath, J.-M. Tarascon, Science 2011, 334, 928-935). A solution to this problem are large-scale energy storage systems (EES), which are vital for distributed power generation development and grid stabilization.

One of the most promising technologies in this field are redox-flow batteries (RFBs), first developed by NASA during the 1970's. RFBs are electrochemical systems that can repeatedly store and convert electrical energy to chemical energy and vice versa, when needed. Redox reactions are employed to store energy in the form of a chemical potential in liquid electrolyte compositions, which are pumped through electrochemical cells. To meet the worldwide need for energy storage systems, which exceeds the multi TWh capacity, a resource in the multi-million-ton scale is required. However, conventional RFBs are dependent on inorganic materials, such as vanadium or bromine, which are prone to either toxicity or restricted availability of the active materials. A more recent approach are water-soluble organic electrolytes. The application of organic molecules as active materials offers a variety of advantages: Organic chemicals are available in sufficient quantities and a high number of redox active species can be mass produced in a cost-efficient manner. In addition, organic redox active molecules can, depending on the synthesis route and starting materials, be produced of renewable resources which is a significant and inherent advantage over inorganic materials. Furthermore, organic redox active species can be altered with functional groups and, therefore, be tailored to fit their desired application. The goal are stable, cheap and highly soluble molecules applicable for large scale energy storage.

Although the possibilities of organic electrolytes appear to be numerous, an electrolyte composition fulfilling the requirements on stability, solubility, cell potential, availability and price to push it to commercialization and large-scale application, still needs to be identified. Well established candidates for organic redox active species are based on quinones, naphthoquinones, anthraquinones, 2,2,6,6-Tetramethylpiperidinyloxyl-based systems, violgens or alloxazines. (Liu W. et al., Chem. Eur. J. 2019, 25, 1649-1664).

Currently, phenazines are considered as very promising organic candidates as redox active species in electrolytes, because phenazines show extraordinary performance and stability. For example, WO 2014/204985 A1 describes the phenazine motif as redox active component for RFBs, however, without providing any working example for its application as a redox active material. WO 2018/231926 A1 describes 7,8-dihydroxy-phenazine-2-sulfonic acid as redox active component in the negolyte of a redox flow battery and discloses a capacity loss of 22% over 40 days (490 cycles) in the examples. Therefore, although phenazines possess high potential as redox active agents in RFBs, further optimization is required for a successful commercialization.

In view of the above, it is the object of the present invention to provide novel electrolytes based on phenazine-derived redox active species, which overcome the above-mentioned drawbacks.

This object is achieved by means of the subject-matter set out below and in the appended claims.

Although the present invention is described in detail below, it is to be understood that this invention is not limited to the particular methodologies, protocols and reagents described herein as these may vary. It is also to be understood that the terminology used herein is not intended to limit the scope of the present invention which will be limited only by the appended claims. Unless defined otherwise, all technical and scientific terms used herein have the same meanings as commonly understood by one of ordinary skill in the art.

In the following, the elements of the present invention will be described. These elements are listed with specific embodiments, however, it should be understood that they may be combined in any manner and in any number to create additional embodiments. The variously described examples and preferred embodiments should not be construed to limit the present invention to only the explicitly described embodiments. This description should be understood to support and encompass embodiments which combine the explicitly described embodiments with any number of the disclosed and/or preferred elements. Furthermore, any permutations and combinations of all described elements in this application should be considered disclosed by the description of the present application unless the context indicates otherwise.

### Definitions

Throughout this specification and the claims which follow, unless the context requires otherwise, the term “comprise”, and variations such as “comprises” and “comprising”, will be understood to imply the inclusion of a stated member, integer or step but not the exclusion of any other non-stated member, integer or step. The term “consist of” is a particular embodiment of the term “comprise”, wherein any other non-stated member, integer or step is excluded. In the context of the present invention, the term “comprise” encompasses the term “consist of”. The term “comprising” thus encompasses “including” as well as “consisting” e.g., a composition “comprising” X may consist exclusively of X or may include something additional e.g., X+Y.

The terms “a” and “an” and “the” and similar reference used in the context of describing the invention (especially in the context of the claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. No language in the specification should be construed as indicating any non-claimed element essential to the practice of the invention.

The word “substantially” does not exclude “completely” e.g., a composition which is “substantially free” from Y may be completely free from Y. Where necessary, the word “substantially” may be omitted from the definition of the invention.

The term “about” in relation to a numerical value x means x±10%.

As used herein (i.e., throughout the present specification), the term “carbocyclyl” or “carbocyclic” refers to a radical of a non-aromatic cyclic hydrocarbon group having preferably from 3 to 14 ring carbon atoms (“C₃₋₁₄ carbocyclyl”) and zero heteroatoms in the non-aromatic ring system. Exemplary C₃₋₆ carbocyclyl groups include, without limitation, cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like. As the foregoing examples illustrate, in certain embodiments, the carbocyclyl group is either monocyclic (“monocyclic carbocyclyl”) or polycyclic (e.g., containing a fused, bridged or spiro ring system such as a bicyclic system (“bicyclic carbocyclyl”) or tricyclic system (“tricyclic carbocyclyl”)) and can be saturated or can contain one or more carbon-carbon double or triple bonds. “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently unsubstituted (an “unsubstituted carbocyclyl”) or substituted (a “substituted carbocyclyl”) with one or more substituents as defined herein.

As used herein, the term “heterocyclyl” or “heterocyclic” refers to a radical of a preferably 3- to 14-membered non-aromatic ring system having ring carbon atoms and 1 to 4 ring heteroatoms, wherein each heteroatom is independently selected from nitrogen, oxygen, and sulfur (“3-14 membered heterocyclyl”). In heterocyclyl groups that contain one or more nitrogen atoms, the point of attachment may be a carbon or nitrogen atom, as valency permits. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”)), and may be saturated or may contain one or more carbon-carbon double or triple bonds. Heterocyclyl polycyclic ring systems may include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the 5 heterocyclyl ring, and in such instances, the number of ring members continue to designate the number of ring members in the heterocyclyl ring system. Unless otherwise specified, each instance of heterocyclyl is independently unsubstituted (an “unsubstituted heterocyclyl”) or substituted (a “substituted heterocyclyl”) with one or more substituents as defined herein.

Exemplary 3-membered heterocyclyl groups containing 1 heteroatom include, without limitation, azirdinyl, oxiranyl, and thiiranyl. Exemplary 4-membered heterocyclyl groups containing 1 heteroatom include, without limitation, azetidinyl, oxetanyl, and thietanyl. Exemplary 5-membered heterocyclyl groups containing 1 heteroatom include, without limitation, tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-membered heterocyclyl groups containing 2 heteroatoms include, without limitation, dioxolanyl, oxathiolanyl and dithiolanyl. Exemplary 5-membered heterocyclyl groups containing 3 heteroatoms include, without limitation, triazolinyl, oxadiazolinyl, and thiadiazolinyl. Exemplary 6-membered heterocyclyl groups containing 1 heteroatom include, without limitation, piperidinyl, tetrahydropyranyl, dihydropyridinyl, and thianyl. Exemplary 6-membered heterocyclyl groups containing 2 heteroatoms include, without limitation, piperazinyl, morpholinyl, dithianyl, and dioxanyl. Exemplary 6-membered heterocyclyl groups containing 2 heteroatoms include, without limitation, triazinanyl. Exemplary 7-membered heterocyclyl groups containing 1 heteroatom include, without limitation, azepanyl, oxepanyl and thiepanyl. Exemplary 8-membered heterocyclyl groups containing 1 heteroatom include, without limitation, azocanyl, oxecanyl and thiocanyl. Exemplary bicyclic heterocyclyl groups include, without limitation, indolinyl, isoindolinyl, dihydrobenzofuranyl, dihydrobenzothienyl, tetrahydrobenzothienyl, tetrahydrobenzofuranyl, tetrahydroindolyl, tetrahydroquinolinyl, tetrahydroisoquinolinyl, decahydroquinolinyl, decahydroisoquinolinyl, octahydrochromenyl, octahydroisochromenyl, decahydronaphthyridinyl, decahydro-1,8-naphthyridinyl, octahydropyrrolo[3,2-b]pyrrole, indolinyl, phthalimidyl, naphthalimidyl, chromanyl, chromenyl, 1H-benzo[e][1,4]diazepinyl, 1,4,5,7-tetrahydropyrano[3,4-b]pyrrolyl, 5,6-dihydro-4H-furo[3,2-b]pyrrolyl, 6,7-dihydro-5H-furo[3,2-b]pyranyl, 5,7-dihydro-4H-thieno[2,3-c]pyranyl, 2,3-dihydro-1H-pyrrolo[2,3-b]pyridinyl, 2,3-dihydrofuro[2,3-b]pyridinyl, 4,5,6,7-tetrahydro-1H-pyrrolo[2,3-b]pyridinyl, 4,5,6,7-tetrahydrothieno[3,2-b]pyridinyl, 4,5,6,7-tetrahydrofuro[3,2-c]pyridinyl, 1,2,3,4-tetrahydro-1,6-naphthyridinyl, and the like.

As used herein, the term “aryl” refers to a radical of a monocyclic or polycyclic (e.g., bicyclic or tricyclic) 4n+2 aromatic ring system (e.g., having 6, 10, or 14 It-electrons shared in a cyclic array) preferably having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents as defined herein.

The term “heteroaryl” refers to a radical of a preferably 5-14 membered monocyclic or polycyclic (e.g., bicyclic, tricyclic) 4n+2 aromatic ring system (e.g., having 6, 10, or 14x electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment may be a carbon or nitrogen atom, as valency permits. Heteroaryl polycyclic ring systems may include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl). Unless otherwise specified, each instance of a heteroaryl group is independently unsubstituted (an “unsubstituted heteroaryl”) or substituted (a “substituted heteroaryl”) with one or more substituents.

Exemplary 5-membered heteroaryl groups containing 1 heteroatom include, without limitation, pyrrolyl, furanyl, and thiophenyl. Exemplary 5-membered heteroaryl groups containing 2 heteroatoms include, without limitation, imidazolyl, pyrazolyl, oxazolyl, isoxazolyl, thiazolyl, and isothiazolyl. Exemplary 5-membered heteroaryl groups containing 3 heteroatoms include, without limitation, triazolyl, oxadiazolyl, and thiadiazolyl. Exemplary 5-membered heteroaryl groups containing 4 heteroatoms include, without limitation, tetrazolyl. Exemplary 6-membered heteroaryl groups containing 1 heteroatom include, without limitation, pyridinyl. Exemplary 6-membered heteroaryl groups containing 2 heteroatoms include, without limitation, pyridazinyl, pyrimidinyl, and pyrazinyl. Exemplary 6-membered heteroaryl groups containing 3 or 4 heteroatoms include, without limitation, triazinyl and tetrazinyl, respectively. Exemplary 7-membered heteroaryl groups containing 1 heteroatom include, without limitation, azepinyl, oxepinyl, and thiepinyl. Exemplary 5,6-bicyclic heteroaryl groups include, without limitation, indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include, without limitation, naphthyridinyl, pteridinyl, quinolinyl, isoquinolinyl, cinnolinyl, quinoxalinyl, phthalazinyl, and quinazolinyl. Exemplary tricyclic heteroaryl groups include, without limitation, phenanthridinyl, dibenzofuranyl, carbazolyl, acridinyl, phenothiazinyl, phenoxazinyl and phenazinyl.

As used herein, the term “nitro” refers to a —NO₂ group; the term “thiol” or “sulfhydryl” refers to a —SH group.

As used herein, the term “hydroxyl” refers to a —OH group, preferably including all of its protonation states, such as —O—.

As used herein, the term “sulfonyl” refers to a —SO₃H group, preferably including all of its protonation states, such as —SO₃—.

As used herein, the term “phosphoryl” refers to a —PO₃H₂ group, preferably including all of its protonation states, such as —PO₃H⁻ and —PO₃²⁻.

As used herein, the term “phosphonyl” refers to a —PO₃R₂ group, wherein each R is H or alkyl, provided at least one R is alkyl, as defined herein, preferably including all of its protonation states, such as —PO₃R⁻.

As used herein, the term “oxo” refers to a ═O group.

As used herein, the term “carboxyl” refers to a —COOH group, preferably including all of its protonation states, such as —COO⁻.

As used herein, the term “oxy” refers to a —O group.

As used herein, the term “halo” or “halogen” refers to fluorine (fluoro, —F), chlorine (chloro, —Cl), bromine (bromo, —Br), or iodine (iodo, —I) groups.

A group is optionally substituted unless expressly provided otherwise. The term “optionally substituted” refers to a group which may be substituted or unsubstituted as defined herein As used herein, the term “unsaturated bond” refers to a double or triple bond. Accordingly, the term “unsaturated” or “partially unsaturated” refers to a moiety that includes at least one double or triple bond. The term “saturated” refers to a moiety that does not contain a double or triple bond, i.e., the moiety only contains single bonds.

As used herein, a “chain” of carbon atoms may be linear (i.e., straight, unbranched) or branched. Typically, a “chain” of carbon atoms does not include cyclic structures. In a “chain” of carbon atoms, the carbon atoms are usually directly linked to each other. In some embodiments, the chain of carbon atoms comprises (exactly) nine carbon atoms. In some embodiments, the chain of carbon atoms comprises (exactly) eight carbon atoms. In some embodiments, the chain of carbon atoms comprises (exactly) seven carbon atoms. In some embodiments, the chain of carbon atoms comprises (exactly) six carbon atoms. In some embodiments, the chain of carbon atoms comprises (exactly) five carbon atoms. In some embodiments, the chain of carbon atoms comprises (exactly) four carbon atoms. In some embodiments, the chain of carbon atoms comprises (exactly) three carbon atoms. In some embodiments, the chain of carbon atoms comprises (exactly) two carbon atoms. In some embodiments, the chain of carbon atoms comprises (exactly) one carbon atom (a single carbon atom). Accordingly, C₁-C₉ chains are preferred and C₁-C₅ chains are more preferred.

The chain of carbon atoms may be substituted or unsubstituted. The chain of carbon atoms may be saturated (i.e., contain saturated bonds only; e.g., -alkyl) or unsaturated (i.e., contain one or more unsaturated bonds; e.g. -alkenyl, -alkinyl).

The term “alkyl” refers to the radical of saturated hydrocarbon groups, including linear (i.e. straight-chain) alkyl groups and branched-chain alkyl groups. Preferably, an alkyl group contains less than 30 carbon atoms, more preferably from 1 to 10 carbon atoms (“C₁₋₁₀ alkyl”), from 1 to 9 carbon atoms (“C₁₋₉ alkyl”), from 1 to 8 carbon atoms (“C₁₋₈alkyl”), from 1 to 7 carbon atoms (“C₁₋₇ alkyl”), or from 1 to 6 carbon atoms (“C₁₋₆ alkyl”). In some embodiments, an alkyl group has 1 to 5 carbon atoms (“C₁₋₅ alkyl”). In some embodiments, an alkyl group may contain 1 to 4 carbon atoms (“C₁₋₄alkyl”), from 1 to 3 carbon atoms (“C₁₋₃ alkyl”), or from 1 to 2 carbon atoms (“C₁₋₂ alkyl”).

Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, iso-butyl), pentyl (C₅) (e.g., n-pentyl, 3-pentanyl, amyl, neopentyl, 3-methyl-2-butanyl, tertiary amyl), and hexyl (C₆) (e.g., n-hexyl). Additional examples of alkyl groups include n-heptyl (C₇), n-octyl (C₃), and the like.

Unless otherwise specified, each instance of an alkyl group is independently unsubstituted (an “unsubstituted alkyl”) or substituted (a “substituted alkyl”) with one or more substituents (e.g., halogen, such as F).

In general, the term “substituted” means that at least one hydrogen present on a group is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds and includes any of the substituents described herein that results in the formation of a stable compound. Compounds described herein contemplates any and all such combinations in order to arrive at a stable compound. Heteroatoms such as nitrogen may have hydrogen substituents and/or any suitable substituent as described herein which satisfy the valencies of the heteroatoms and results in the formation of a stable moiety. Compounds described herein are not intended to be limited in any manner by the exemplary substituents described herein.

In certain embodiments, the alkyl group is an unsubstituted C₁₋₁₀alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tent-butyl (tent-Bu or t-Bu), unsubstituted sec-butyl (sec-Bu), unsubstituted isobutyl (i-Bu)). In certain embodiments, the alkyl group is a substituted C₁₋₁₀ alkyl (such as substituted C₁₋₆alkyl, e.g., —CF₃, Bn).

Exemplary substituents may include, for example, a halogen, a hydroxyl, a carbonyl (such as a carboxyl, an alkoxycarbonyl, a formyl, or an acyl), a thiocarbonyl (such as a thioester, a thioacetate, or a thioformate), an alkoxyl, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety, or a Ga group as defined herein.

Substituents may themselves be substituted. For instance, the substituents of a “substituted alkyl” may include both substituted and unsubstituted forms of amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Cycloalkyls may be further substituted with alkyls, alkenyls, alkoxys, alkylthios, aminoalkyls, carbonyl-substituted alkyls, —CF₃, —CN, and the like.

The term “haloalkyl” refers to a substituted alkyl group, wherein one or more of the hydrogen atoms are independently replaced by a halogen, e.g., fluoro, bromo, chloro, or iodo. “Perhaloalkyl” is a subset of haloalkyl and refers to an alkyl group wherein all of the hydrogen atoms are independently replaced by a halogen, e.g., fluoro, bromo, chloro, or iodo. Examples of haloalkyl groups include —CF₃, —CF₂CF₃, —CF₂CF₂CF₃, —CCl₃, —CFCl₂, —CF₂Cl, and the like.

The term “heteroalkyl” refers to an alkyl group as defined herein, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent hydrocarbon chain. Unless otherwise specified, each instance of a heteroalkyl group is independently unsubstituted (an “unsubstituted heteroalkyl”) or substituted (a “substituted heteroalkyl”) with one or more substituents as defined herein.

The term “alkenyl”, as used herein, refers to the radical of hydrocarbon groups containing at least one double bond, including linear (i.e. straight-chain) alkenyl groups and branched-chain alkenyl groups. Preferably, an alkenyl group contains less than 30 carbon atoms, more preferably from 1 to 10 carbon atoms (“C₁₋₁₀ alkenyl”), from 1 to 9 carbon atoms (“C₁₋₉ alkenyl”), from 1 to 8 carbon atoms (“C₁₋₈ alkenyl”), from 1 to 7 carbon atoms (“C₁₋₇ alkenyl”), or from 1 to 6 carbon atoms (“C₁₋₆ alkenyl”). In some embodiments, an alkenyl group has 1 to 5 carbon atoms (“C₁₋₅ alkenyl”). In some embodiments, an alkenyl group may contain 1 to 4 carbon atoms (“C₁₋₄alkenyl”), from 1 to 3 carbon atoms (“C₁₋₃ alkenyl”), or from 1 to 2 carbon atoms (“C₁₋₂ alkenyl”).

Examples of C₁₋₆alkenyl groups include vinyl (C₂), allyl (C₃), butenyl (C₄), pentenyl (C₅) and hexenyl (C₆).

Preferably, the alkenyl group includes a single double bond. More preferably, any other bonds between carbon atoms in the alkenyl group are single bonds (saturated).

Unless otherwise specified, each instance of an alkenyl group is independently unsubstituted (an “unsubstituted alkenyl”) or substituted (a “substituted alkenyl”) with one or more substituents (e.g., halogen, such as F), as described above.

The term “alkinyl”, as used herein, refers to the radical of hydrocarbon groups containing at least one triple bond, including linear (i.e. straight-chain) alkinyl groups and branched-chain alkinyl groups. Preferably, an alkinyl group contains less than 30 carbon atoms, more preferably from 1 to 10 carbon atoms (“C₁₋₁₀alkinyl”), from 1 to 9 carbon atoms (“C₁₋₉alkinyl”), from 1 to 8 carbon atoms (“C₁₋₃ alkinyl”), from 1 to 7 carbon atoms (“C₁₋₇ alkinyl”), or from 1 to 6 carbon atoms (“C₁₋₆ alkinyl”). In some embodiments, an alkinyl group has 1 to 5 carbon atoms (“C₁₋₅ alkinyl”). In some embodiments, an alkinyl group may contain 1 to 4 carbon atoms (“C₁₋₄alkinyl”), from 1 to 3 carbon atoms (“C₁₋₃ alkinyl”), or from 1 to 2 carbon atoms (“C₁₋₂ alkinyl”).

Examples of C₁₋₆ alkinyl groups include ethinyl (C₂), propinyl (C₃), butinyl (C₄), pentinyl (C₅) and hexinyl (C₆).

Preferably, the alkinyl group includes a single triple bond. More preferably, any other bonds between carbon atoms in the alkinyl group are single bonds (saturated).

Unless otherwise specified, each instance of an alkinyl group is independently unsubstituted (an “unsubstituted alkinyl”) or substituted (a “substituted alkinyl”) with one or more substituents (e.g., halogen, such as F), as described above.

The term “ester” refers to groups or molecules which contain a carbon or a heteroatom bound to an oxygen atom which is bonded to the carbon of a carbonyl group. The term “ester” includes alkoxycarboxy groups such as methoxycarbonyl, ethoxycarbonyl, propoxycarbonyl, butoxycarbonyl, pentoxycarbonyl, etc., the alkyl, alkenyl, or alkinyl groups are as defined above.

The terms “alkoxyl” or “alkoxy” as used herein refers to group of formula —OR, wherein R is an alkyl group, as defined herein. Exemplary alkoxyl groups include methoxy, ethoxy, propyloxy, tert-butoxy and the like.

The term “amine” or “amino” includes compounds where a nitrogen atom is covalently bonded to at least one carbon atom or heteroatom. The term “alkyl amino” includes groups and compounds where the nitrogen is bound to at least one additional alkyl group. The term “dialkyl amino” includes groups where the nitrogen atom is bound to at least two additional alkyl groups. The term “arylamino” and “diarylamino” include groups where the nitrogen is bound to at least one or two aryl groups, respectively. The term “alkylarylamino,” “alkylaminoaryl” or “arylaminoalkyl” refers to an amino group which is bound to at least one alkyl group and at least one aryl group. The term “alkaminoalkyl” refers to an alkyl, alkenyl, or alkynyl group bound to a nitrogen atom which is also bound to an alkyl group. The term “amine” or “amino” in particular refers to a —NH₂ group, preferably including any of its protonation states, such as —NH₃.

The term “amide” or “aminocarboxy” includes compounds or moieties which contain a nitrogen atom which is bound to the carbon atom of a carbonyl or a thiocarbonyl group. The term includes “alkaminocarboxy” groups which include alkyl, alkenyl, or alkynyl groups bound to an amino group bound to a carboxy group. It includes arylaminocarboxy groups which include aryl or heteroaryl moieties bound to an amino group which is bound to the carbon of a carbonyl or thiocarbonyl group. The terms “alkylaminocarboxy,” “alkenylaminocarboxy,” “alkynylaminocarboxy,” and “arylaminocarboxy” include moieties where alkyl, alkenyl, alkynyl and aryl moieties, respectively, are bound to a nitrogen atom which is in turn bound to the carbon of a carbonyl group.

The term “carbonyl” refers to a group which contains a carbon atom connected with a double bond to an oxygen or a sulfur atom. Examples of moieties which contain a carbonyl include aldehydes, ketones, carboxylic acids, amides, esters, anhydrides, etc.

As used herein, the term “aromatic moiety” refers to any moiety comprising an aromatic structure. An aromatic structure is typically characterized by a cyclic (ring-shaped), planar (flat) structure with a ring of resonance bonds that gives increased stability compared to other geometric or connective arrangements with the same set of atoms (e.g., aliphatic cyclic structures). Examples of aromatic structures, which may be included in aromatic moieties, include aromatic annulenes, such as benzene, cyclotetradecaheptaene, [6]annulene and [18]annulene; heterocyclic aromatic moieties, wherein one or more of the atoms in the aromatic ring is of an element other than carbon, such as furan, pyridine, pyrazine, pyrrole, imidazole, pyrazole, oxazole, thiophene, and their benzannulated analogs (benzimidazole, for example); polycyclic aromatic hydrocarbons, which contain two or more simple aromatic rings fused together by sharing two neighboring carbon atoms, such as naphthalene, anthracene, and phenanthrene; and substituted aromatic structures, which are substituted as described above. For example, an aromatic moiety may comprise benzene.

### Electrolyte Composition

In a first aspect the present invention provides an electrolyte composition comprising:
(i) a first redox active compound, which is characterized by General Formula (I), or a salt thereof:

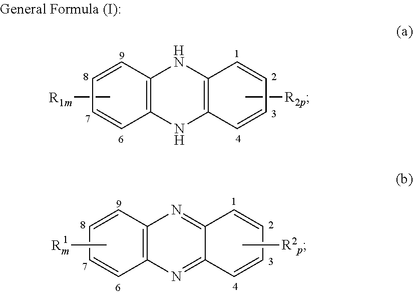

wherein:
R¹ and R² are selected independently from each other from the group consisting of Rₐ—R_{d}, Rₐ—R_{b}—R_{c}, Rₐ—R_{d}—R_{c}, R_{b}—R_{c}, R_{b}—Rₐ—R_{b}—R_{c}, R_{b}—Rₐ—R_{d}—R_{c}, R_{b}—Rₑ(R_{b}—R_{c})₂, R_{b}—Rₑ(R_{d}—R_{c})₂, R_{b}—N(R_{b}—R_{c})₃X, R_{c}, R_{d}, R_{d}—R_{c}, R_{d}—Rₐ—R_{b}—R_{c}, R_{d}—Rₐ—R_{d}—R_{c}, R_{d}—Rₑ(R_{b}—R_{c})₂, R_{d}—Rₑ(R_{d}—R_{c})₂, R_{d}—N(R_{d}—R_{c})₃X, R_{d}—N(R_{b}—R_{c})₃X, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X,
   wherein
   Rₐ is selected from the group consisting of —SO₃—, —SO₂(NH)—, —(NH)SO₂—, —SO₂(NR_{d})—, —(NR_{d})SO₂—, —OSO₃—, —OSO₂(NH)—, —(NH)SO₂O—, —OSO₂NR_{d}—, —(NR_{d})SO₂O—, —PO₃H—, —PO₂H(NH)—, —PO₂HNR_{d}—, —OPO₃H—, —OPO₂H(NH)—, —OPO₂HNR_{d}—, —C(═O)O—, —CO(NH)—, —(NH)CO—, —CONR_{d}—, —(NR_{d})CO—, —O—, —NH—, -heteroaryl, and -heterocyclyl,
   R_{b} is selected from the group consisting of —CH₂C(OH)HR_{d}—, —R_{d}—O—R_{d}—, —R_{d}—(OC₂H₄)ₙ—, and R_{d}—(OCH₂C(CH₃)H)ₙ—, wherein n is an integer selected from 1 to 50,
   R_{c} is selected from the group consisting of —H, —OH, —OR_{d}, —OC(═O)R_{d}, —NH₂, —NH(R_{d}), —N(R_{d})₂, —N(R_{d})₃X, —C(═O)NH₂, —C(═O)(NH)R_{d}, —C(═O)OH, —C(═O)R_{b}—H, —SO₃H, —SO₃R_{d}, —SO₂NH₂, —SO₂(NH)R_{d}, —OSO₃H, —OSO₃R_{d}, —OSO₂NH₂, —OSO₂(NH)R_{d}, —PO₃H₂, —PO₃HR_{d}, —PO₃(R_{d})₂, —OPO₃H₂, —OPO₃HR_{d}, —OPO₃(R_{d})₂, -halogen, -aryl, —CHO, —CN, -heteroaryl, and -heterocyclyl,
   R_{d} is a linear or branched, saturated or unsaturated C₁-C₉ chain,
   Rₑ is selected from the group consisting of —PO₃—, —OPO₂—, and —N—, and
   X is selected from the group consisting of —Cl, —Br, —I, and ½ —SO₄; and
wherein
m and p are selected independently from each other from any integer of 0, 1, 2, 3, and 4;
(ii) a second redox active compound, which is not characterized by General Formula (I); and
(iii) a solvent.

Accordingly, the present invention provides an electrolyte composition comprising a first redox active compound, which is a phenazine (derivative) according to General Formula (I); and a second redox active compound, which is not a phenazine (derivative). In particular, the first redox active compound and the second redox active compound are typically distinct molecules (separate entities) in the electrolyte composition of the invention. In other words, the first redox active compound and the second redox active compound are usually not linked, coupled or bound to each other.

The present inventors have surprisingly found that—in comparison to electrolyte compositions of the prior art comprising a single redox active compound, which is a phenazine (derivative), only—the combination of a first redox active compound, which is a phenazine (derivative) of General Formula (I), and a second redox active compound, which is not a phenazine (derivative), according to the present invention (a) improves the maximum cell performance, (b) improves the round-trip efficiency and (c) decreases the cell resistance.

As used herein, an “electrolyte composition” is typically (suitable) for use in a redox flow battery. In particular, the electrolyte composition may be used as negolyte or posolyte in a redox flow battery. Such electrolyte compositions may be also referred to as negolyte or posolyte composition. Accordingly, the electrolyte composition usually contains the redox active compound in a purified form, i.e. separated from starting materials and intermediate products of the synthesis of the redox active compound. In other words, an electrolyte composition (for use in a redox flow battery) typically differs from compositions used or obtained in the synthesis of a redox active compound. In some embodiments, the second redox active compound of the electrolyte composition is not a starting material or intermediate product in the synthesis of the first redox active compound. For example, if the electrolyte composition comprises 7,8-dihydroxy phenazine-2-sulfonic acid (DHPS) as first redox active compound, it may not comprise 2,5-dihydroxy-1,4-benzoquinone (or other starting materials or intermediate products in the synthesis of DHPS). Therefore, in some embodiments, the electrolyte composition does not comprise 2,5-dihydroxy-1,4-benzoquinone.

As used herein, the term “redox active compound” refers to a compound, which is capable of forming redox pairs having different oxidation and reduction states. Accordingly, a redox active compound may be present in the electrolyte composition in its oxidized and/or in its reduced state. In a flow battery, a redox active compound usually refers to the chemical species that participate in the redox reactions during the charge and discharge process. Accordingly, the term “redox active” refers in particular to the conditions applied in redox flow batteries. This means that a redox active compound is typically a compound, which is capable of forming redox pairs having different oxidation and reduction states under (working) conditions in a redox flow battery, i.e. in particular when the applied cell voltage is lower than 2.5 V. Under such conditions, for example NaOH or KOH (and other alkali hydroxides) are not redox active compounds.

It will be understood that the term “redox active compound” encompasses compounds in at least one, typically two or even more than two oxidation/reduction states. Each of the first and second “redox active compound” may thus be present both in its reduced and in its oxidized form, i.e. forming a redox pair (a first and second redox pair). Specifically, when referring to “redox active compounds according to General Formulas (I), (II), (Ill) and/or (IV)” herein, reference is made to both redox active compounds both in their oxidized form (as represented by General Formula (I)(b), (II)(b), (III)(b) and (IV)(b), respectively) and their reduced form (as represented by General Formula (I)(a), (II)(a), (Ill)(a) and (IV)(a), respectively).

### First Redox Active Compound

The first redox active compound is according to General Formula (I), or a salt thereof:

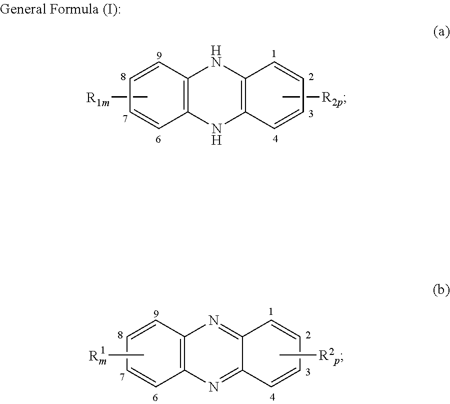

wherein:
R¹ and R² are selected independently from each other from the group consisting of Rₐ—R_{d}, Rₐ—R_{b}—R_{c}, Rₐ—R_{d}—R_{c}, R_{b}—R_{c}, R_{b}—Rₐ—R_{b}—R_{c}, R_{b}—Rₐ—R_{d}—R_{c}, R_{b}—Rₑ(R_{b}—R_{c})₂, R_{b}—Rₑ(R_{d}—R_{c})₂, R_{b}—N(R_{b}—R_{c})₃X, R_{c}, R_{d}, R_{d}—R_{c}, R_{d}—Rₐ—R_{b}—R_{c}, R_{d}—Rₐ—R_{d}—R_{c}, R_{d}—Rₑ(R_{b}—R_{c})₂, R_{d}—Rₑ(R_{d}—R_{c})₂, R_{d}—N(R_{d}—R_{c})₃X, R_{d}—N(R_{b}—R_{c})₃X, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X,
   wherein
   Rₐ is selected from the group consisting of —SO₃—, —SO₂(NH)—, —(NH)SO₂—, —SO₂(NR_{d})—, —(NR_{d})SO₂—, —OSO₃—, —OSO₂(NH)—, —(NH)SO₂O—, —OSO₂NR_{d}—, —(NR_{d})SO₂O—, —PO₃H—, —PO₂H(NH)—, —PO₂HNR_{d}—, —OPO₃H—, —OPO₂H(NH)—, —OPO₂HNR_{d}—, —C(═O)O—, —CO(NH)—, —(NH)CO—, —CONR_{d}—, —(NR_{d})CO—, —O—, —NH—, -heteroaryl, and -heterocyclyl,
   R_{b} is selected from the group consisting of —CH₂C(OH)HR_{d}—, —R_{d}—O—R_{d}—, —R_{d}—(OC₂H₄)ₙ—, and R_{d}—(OCH₂C(CH₃)H)ₙ—, wherein n is an integer selected from 1 to 50,
   R_{c} is selected from the group consisting of —H, —OH, —OR_{d}, —OC(═O)R_{d}, —NH₂, —NH(R_{d}), —N(R_{d})₂, —N(R_{d})₃X, —C(═O)NH₂, —C(═O)(NH)R_{d}, —C(═O)OH, —C(═O)R_{b}—H, —SO₃H, —SO₃R_{d}, —SO₂NH₂, —SO₂(NH)R_{d}, —OSO₃H, —OSO₃R_{d}, —OSO₂NH₂, —OSO₂(NH)R_{d}, —PO₃H₂, —PO₃HR_{d}, —PO₃(R_{d})₂, —OPO₃H₂, —OPO₃HR_{d}, —OPO₃(R_{d})₂, -halogen, -aryl, —CHO, —CN, -heteroaryl, and -heterocyclyl,
   R_{d} is a linear or branched, saturated or unsaturated C₁-C₉ chain,
   Rₑ is selected from the group consisting of —PO₃—, —OPO₂—, and —N—, and
   X is selected from the group consisting of —Cl, —Br, —I, and ½ —SO₄; and
wherein
m and p are selected independently from each other from any integer of 0, 1, 2, 3, and 4.

The compounds according to General Formula (I) may be classified as (substituted) phenazines. Accordingly, the first redox active compound is a phenazine/phenazine derivative. In this context, the term “phenazine derivative” refers to a substituted phenazine, in particular comprising substituents R¹ and/or R² according to General Formula (I). In particular, the first redox active compound is a low molecular weight compound. The first redox active compound may, for example, advantageously be obtained from lignin, crude oil, coal or pure organic substances. In particular, lignin derivatives produced as waste or by-products of the pulping industry have previously largely been unexploited and can be valorized to obtain a phenazine (derivative) of General Formula (I).

R¹ and R² of General Formula (I) may be the same or different. Preferably, R¹ and R² are selected independently from each other from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. More preferably, R¹ and R² of General Formula (I) are selected independently from each other from the group consisting of Rₐ—R_{b}—R_{c}, Rₐ—R_{d}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X.

In some embodiments, R¹ of General Formula (I) is Rₐ—R_{b}—R_{c}, and R² is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R¹ of General Formula (I) is Rₐ—R_{d}—R_{c}, and R² is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R¹ of General Formula (I) is R_{b}—R_{c}, and R² is 10 selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R¹ of General Formula (I) is R_{c}, and R² is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R¹ of General Formula (I) is R_{d}, and R² is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R¹ of General Formula (I) is R_{d}—R_{c}, and R² is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R¹ of General Formula (I) is Rₑ(R_{b}—R_{c})₂, and R² is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R¹ of General Formula (I) is Rₑ(R_{d}—R_{c})₂, and R² is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R¹ of General Formula (I) is Rₑ(R_{d}—R_{c})(R_{b}—R_{c}), and R² is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R¹ of General Formula (I) is —N(R_{b}—R_{c})₃X, and R² is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R¹ of General Formula (I) is —N(R_{d}—R_{c})₃X, and R² is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X.

In some embodiments, R² of General Formula (I) is Rₐ—R_{b}—R_{c}, and R¹ is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R² of General Formula (I) is Rₐ—R_{d}—R_{c}, and R¹ is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R² of General Formula (I) is R_{b}—R_{c}, and R¹ is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R² of General Formula (I) is R_{c}, and R¹ is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R² of General Formula (I) is R_{d}, and R¹ is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R² of General Formula (I) is R_{d}—R_{c}, and R¹ is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R² of General Formula (I) is Rₑ(R_{b}—R_{c})₂, and R¹ is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R² of General Formula (I) is Rₑ(R_{d}—R_{c})₂, and R¹ is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R² of General Formula (I) is Rₑ(R_{d}—R_{c})(R_{b}—R_{c}), and R¹ is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R² of General Formula (I) is —N(R_{b}—R_{c})₃X, and R¹ is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X. In some embodiments, R² of General Formula (I) is —N(R_{d}—R_{c})₃X, and R¹ is selected from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X.

Preferably, each of R¹ and R² of General Formula (I) is Rₐ—R_{b}—R_{c}. It is also preferred that each of R¹ and R² of General Formula (I) is Rₐ—R_{d}—R_{c}. It is also preferred that each of R¹ and R² of General Formula (I) is R_{c}. It is also preferred that each of R¹ and R² of General Formula (I) is R_{d}. It is also preferred that each of R¹ and R² of General Formula (I) is R_{d}—R_{c}. It is also preferred that each of R¹ and R² of General Formula (I) is Rₑ(R_{b}—R_{c})₂. It is also preferred that each of R¹ and R² of General Formula (I) is Rₑ(R_{d}—R_{c})₂. It is also preferred that each of R¹ and R² of General Formula (I) is Rₑ(R_{d}—R_{c})(R_{b}—R_{c}). It is also preferred that each of R¹ and R² of General Formula (I) is —N(R_{b}—R_{c})₃X.

It is also preferred that R¹ is Rₐ—R_{b}—R_{c} and R² is Rₐ—R_{d}—R_{c}. It is also preferred that R¹ is Rₐ—R_{b}—R_{c} and R² is R_{c}. It is also preferred that R¹ is Rₐ—R_{b}—R_{c} and R² is R_{d}. It is also preferred that R¹ is Rₐ—R_{b}—R_{c} and R² is R_{d}—R_{c}. It is also preferred that R¹ is Rₐ—R_{b}—R_{c} and R² is Rₑ(R_{b}—R_{c})₂. It is also preferred that R¹ is Rₐ—R_{b}—R_{c} and R² is Rₑ(R_{d}—R_{c})₂. It is also preferred that R¹ is Rₐ—R_{b}—R_{c} and R² is Rₑ(R_{d}—R_{c})(R_{b}—R_{c}). It is also preferred that R¹ is Rₐ—R_{b}—R_{c} and R² is —N(R_{b}—R_{c})₃X.

It is also preferred that R¹ is Rₐ—R_{d}—R_{c} and R² is Rₐ—R_{b}—R_{c}. It is also preferred that R¹ is Rₐ—R_{d}—R_{c} and R² is R_{c}. It is also preferred that R¹ is Rₐ—R_{d}—R_{c} and R² is R_{d}. It is also preferred that R¹ is Rₐ—R_{d}—R_{c} and R² is R_{d}—R_{c}. It is also preferred that R¹ is Rₐ—R_{d}—R_{c} and R² is Rₑ(R_{b}—R_{c})₂. It is also preferred that R¹ is Rₐ—R_{d}—R_{c} and R² is Rₑ(R_{d}—R_{c})₂. It is also preferred that R¹ is Rₐ—R_{d}—R_{c} and R² is Rₑ(R_{d}—R_{c})(R_{b}—R_{c}). It is also preferred that R¹ is Rₐ—R_{d}—R_{c} and R² is —N(R_{b}—R_{c})₃X.

It is also preferred that R¹ is R_{c} and R² is Rₐ—R_{b}—R_{c}. It is also preferred that R¹ is R_{c} and R² is Rₐ—R_{d}—R_{c}.

It is also preferred that R¹ is R_{c} and R² is R_{d}. It is also preferred that R¹ is R_{c} and R² is R_{d}—R_{c}. It is also preferred that R¹ is R_{c} and R² is Rₑ(R_{b}—R_{c})₂. It is also preferred that R¹ is R_{c} and R² is Rₑ(R_{d}—R_{c})₂. It is also preferred that R¹ is R_{c} and R² is Rₑ(R_{d}—R_{c})(R_{b}—R_{c}). It is also preferred that R¹ is R_{c} and R² is —N(R_{b}—R_{c})₃X.

It is also preferred that R¹ is R_{d} and R² is Rₐ—R_{b}—R_{c}. It is also preferred that R¹ is R_{d} and R² is Rₐ—R_{d}—R_{c}. It is also preferred that R¹ is R_{d} and R² is R_{c}. It is also preferred that R¹ is R_{d} and R² is R_{d}—R_{c}. It is also preferred that R¹ is R_{d} and R² is Rₑ(R_{b}—R_{c})₂. It is also preferred that R¹ is R_{d} and R² is Rₑ(R_{d}—R_{c})₂. It is also preferred that R¹ is R_{d} and R² is Rₑ(R_{d}—R_{c})(R_{b}—R_{c}). It is also preferred that R¹ is R_{d} and R² is —N(R_{b}—R_{c})₃X.

It is also preferred that R¹ is R_{d}—R_{c} and R² is Rₐ—R_{b}—R_{c}. It is also preferred that R¹ is R_{d}—R_{c} and R² is Rₐ—R_{d}—R_{c}. It is also preferred that R¹ is R_{d}—R_{c} and R² is R_{c}. It is also preferred that R¹ is R_{d}—R_{c} and R² is R_{d}. It is also preferred that R¹ is R_{d}—R_{c} and R² is Rₑ(R_{b}—R_{c})₂. It is also preferred that R¹ is R_{d}—R_{c} and R² is Rₑ(R_{d}—R_{c})₂. It is also preferred that R¹ is R_{d}—R_{c} and R² is Rₑ(R_{d}—R_{c})(R_{b}—R_{c}). It is also preferred that R¹ is R_{d}—R_{c} and R² is —N(R_{b}—R_{c})₃X.

It is also preferred that R¹ is Rₑ(R_{b}—R_{c})₂ and R² is Rₐ—R_{b}—R_{c}. It is also preferred that R¹ is Rₑ(R_{b}—R_{c})₂ and R² is Rₐ—R_{d}—R_{c}. It is also preferred that R¹ is Rₑ(R_{b}—R_{c})₂ and R² is R_{c}. It is also preferred that R¹ is Rₑ(R_{b}—R_{c})₂ and R² is R_{d}. It is also preferred that R¹ is Rₑ(R_{b}—R_{c})₂ and R² is Rₑ(R_{d}—R_{c})₂. It is also preferred that R¹ is Rₑ(R_{b}—R_{c})₂ and R² is R_{d}—R_{c}. It is also preferred that R¹ is Rₑ(R_{b}—R_{c})₂ and R² is Rₑ(R_{d}—R_{c})(R_{b}—R_{c}). It is also preferred that R¹ is Rₑ(R_{b}—R_{c})_{b} and R² is —N(R_{b}—R_{c})₃X.

It is also preferred that R¹ is Rₑ(R_{d}—R_{c})₂ and R² is Rₐ—R_{b}—R_{c}. It is also preferred that R¹ is Rₑ(R_{d}—R_{c})₂ and R² is Rₐ—R_{d}—R_{c}. It is also preferred that R¹ is Rₑ(R_{d}—R_{c})₂ and R² is R_{c}. It is also preferred that R¹ is Rₑ(R_{d}—R_{c})₂ and R² is R_{d}. It is also preferred that R¹ is Rₑ(R_{d}—R_{c})₂ and R² is Rₑ(R_{b}—R_{c})₂. It is also preferred that R¹ is Rₑ(R_{d}—R_{c})₂ and R² is R_{d}—R_{c}. It is also preferred that R¹ is Rₑ(R_{d}—R_{c})₂ and R² is Rₑ(R_{d}—R_{c})(R_{b}—R_{c}). It is also preferred that R¹ is Rₑ(R_{d}—R_{c})₂ and R² is —N(R_{b}—R_{c})₃X.

It is also preferred that R¹ is Rₑ(R_{d}—R_{c})(R_{b}—R_{c}) and R² is Rₐ—R_{b}—R_{c}. It is also preferred that R¹ is Rₑ(R_{d}—R_{c})(R_{b}—R_{c}) and R² is Rₐ—R_{d}—R_{c}. It is also preferred that R¹ is Rₑ(R_{d}—R_{c})(R_{b}—R_{c}) and R² is R_{c}. It is also preferred that R¹ is Rₑ(R_{d}—R_{c})(R_{b}—R_{c}) and R² is R_{d}. It is also preferred that R¹ is Rₑ(R_{d}—R_{c})(R_{b}—R_{c}) and R² is Rₑ(R_{b}—R_{c})₂. It is also preferred that R¹ is Rₑ(R_{d}—R_{c})(R_{b}—R_{c}) and R² is R_{d}—R_{c}. It is also preferred that R¹ is Rₑ(R_{d}—R_{c})(R_{b}—R_{c}) and R² is Rₑ(R_{d}—R_{c})₂. It is also preferred that R¹ is Rₑ(R_{d}—R_{c})(R_{b}—R_{c}) and R² is —N(R_{b}—R_{c})₃X.

It is also preferred that R¹ is —N(R_{b}—R_{c})₃X and R² is Rₐ—R_{b}—R_{c}. It is also preferred that R¹ is —N(R_{b}—R_{c})₃X and R² is Rₐ—R_{d}—R_{c}. It is also preferred that R¹ is —N(R_{b}—R_{c})₃X and R² is R_{c}. It is also preferred that R¹ is —N(R_{b}—R_{c})₃X and R² is R_{d}. It is also preferred that R¹ is —N(R_{b}—R_{c})₃X and R² is Rₑ(R_{b}—R_{c})₂. It is also preferred that R¹ is —N(R_{b}—R_{c})₃X and R² is R_{d}—R_{c}. It is also preferred that R¹ is —N(R_{b}—R_{c})₃X and R² is Rₑ(R_{d}—R_{c})₂. It is also preferred that R¹ is —N(R_{b}—R_{c})₃X and R² is Rₑ(R_{d}—R_{c})(R_{b}—R_{c}).

Preferably, Rₐ is selected from the group consisting of —PO₃H—, —CO(NH)—, —(NH)CO—, —CONR_{d}—, —(NR_{d})CO—, —O—, —NH—, -heteroaryl, and -heterocyclyl. More preferably, Rₐ is —O— or —NH—. In some embodiments, Rₐ is —O—. In other embodiments, Rₐ is —NH—.

Preferably, R_{b} is selected from the group consisting of —CH₂C(OH)HR_{d}—, —R_{d}—O—R_{d}—, and —R_{d}—(OC₂H₄)ₙ—. More preferably, R_{b} is —CH₂C(OH)HR_{d}— or —R_{d}—(OC₂H₄)ₙ—. In some embodiments, R_{b} is —CH₂C(OH)HR_{d}—. In other embodiments, R_{b} is —R_{d}—(OC₂H₄)ₙ—.

Preferably, n is an integer selected from 1 to 20; e.g. 1, 2, 3, 4, 5, 6, 7, 8, 9, 10, 11, 12, 13, 14, 15, 16, 17, 18, 19 or 20. More preferably n is an integer selected from 1 to 5. In some embodiments, n is 1. In other embodiments, n is 2. In other embodiments, n is 3. In other embodiments, n is 4. In other embodiments, n is 5.

Preferably, R_{c} is selected from the group consisting of —H, —OH, —OR_{d}, —NH₂, —N(R_{d})₃X, —C(═O)NH₂, —C(═O)OH, —SO₃H, —OSO₃H, —PO₃H₂, -halogen, -aryl, —CN, -heteroaryl, and -heterocyclyl. More preferably, R_{c} is selected from the group consisting of —H, —OH, —NH₂, —C(═O)OH, —SO₃H, -aryl, —CN, -heteroaryl, and -heterocyclyl. In some embodiments, R_{c} is —H. In other embodiments, R_{c} is —OH. In other embodiments, R_{c} is —NH₂. In other embodiments, R_{c} is —C(═O)OH. In other embodiments, R_{c} is —SO₃H. In other embodiments, R_{c} is -aryl. In other embodiments, R_{c} is —CN. In other embodiments, R_{c} is -heteroaryl. In other embodiments, R_{c} is -heterocyclyl.

Preferably, R_{d} is a linear or branched, saturated C₁-C₉ chain. More preferably, R_{d} is a linear or branched, saturated C₁-C₅ chain. In some embodiments, R_{d} is a linear C₁-C₉ alkyl, which may be substituted, as described above, or unsubstituted. In other embodiments, R_{d} is a branched C₁-C₉ alkyl, which may be substituted, as described above, or unsubstituted. Preferably, R_{d} is a linear C₁-C₅ alkyl, which may be substituted, as described above, or unsubstituted. It is also preferred that R_{d} is a branched C₁-C₅ alkyl, which may be substituted, as described above, or unsubstituted. More preferably, R_{d} is a linear C₁-C₄ alkyl, which may be substituted, as described above, or unsubstituted. It is also more preferred that R_{d} is a branched C₁-C₄ alkyl, which may be substituted, as described above, or unsubstituted. Even more preferably, R_{d} is a linear C₁-C₃ alkyl, which may be substituted, as described above, or unsubstituted. It is also even more preferred that R_{d} is a branched C₁-C₃ alkyl, which may be substituted, as described above, or unsubstituted. Still more preferably, R_{d} is a linear C₁-C₂ alkyl, which may be substituted, as described above, or unsubstituted. It is also still more preferred that R_{d} is a branched C₁-C₂ alkyl, which may be substituted, as described above, or unsubstituted.

Preferably, X is selected from the group consisting of —Cl, —Br, and ½ —SO₄. More preferably, X is —Cl or ½ —SO₄. In some embodiments, X is —Cl. In other embodiments, X is % —SO₄.

In General Formula (I), “m” is an integer preferably selected from 0, 1, 2, and 3. More preferably, m is selected from 0, 1 and 2. In some embodiments, m is 1 or 2. In other embodiments, m is 0.

In General Formula (I), “p” is an integer preferably selected from 0, 1, and 2. More preferably, p is 0 or 1. In some instances, p is 0. In other instances, p is 1.

In some embodiments, the electrolyte composition comprises a first redox active compound according to General Formula (I), wherein
R¹ and R² are selected independently from each other from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X,
   wherein
   Rₐ is selected from the group consisting of —CO(NH)—, —(NH)CO—, —CONR_{d}—, —(NR_{d})CO—, —O—, —NH—, -heteroaryl, and -heterocyclyl,
   R_{b} is selected from the group consisting of —CH₂C(OH)HR_{d}—, —R_{d}—O—R_{d}—, and —R_{d}—(OC₂H₄)—, wherein n is an integer selected from 1 to 20,
   R_{c} is selected from the group consisting of —H, —OH, —OR_{d}, —NH₂, —N(R_{d})₃X, —C(═O)NH₂, —C(═O)OH, —SO₃H, —OSO₃H, —PO₃H₂, -halogen, -aryl, —CN, -heteroaryl, and -heterocyclyl,
   R_{d} is a linear or branched, saturated C₁-C₉ chain,
   Rₑ is —N—, and
   X is selected from the group consisting of —Cl, —Br, and Y—SO₄; and
wherein
m is an integer selected from 0, 1, 2, and 3; and
p is an integer selected from 0, 1, and 2.

Preferably, the electrolyte composition comprises a first redox active compound according to General Formula (I), wherein
R¹ and R² are selected independently from each other from the group consisting of Rₐ—R_{b}—R_{c}, Rₐ—R_{d}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), and —N(R_{b}—R_{c})₃X,
   wherein
   Rₐ is —O— or —NH—,
   R_{b} is —CH₂C(OH)HR_{d}— or —R_{d}—(OC₂H₄)ₙ—, wherein n is an integer selected from 1 to 5,
   R_{c} is selected from the group consisting of —H, —OH, —NH₂, —C(═O)OH, —SO₃H, -aryl, —CN, -heteroaryl, and -heterocyclyl,
   R_{d} is a linear or branched, saturated C₁-C₅ chain,
   Rₑ is —N—, and
   X is —Cl or ½ —SO₄; and
wherein
m is an integer selected from 0, 1, and 2; and
p is 0 or 1.

In General Formula (I) R¹ is preferably positioned at ring position 7 and/or 8. In some embodiments, General Formula (I) contains (exactly or at least) two R¹ substituents, which are preferably positioned at ring position 7 and 8. For example, m is 2 and R¹ is positioned at ring position 7 and 8. In other embodiments, General Formula (I) contains a single R¹ substituent only, which is preferably positioned at ring position 7 or 8. For example, m is 1 and R¹ is positioned at ring position 7; or m is 1 and R¹ is positioned at ring position 8.

In General Formula (I) R² is preferably positioned at ring position 2 and/or 3. In some embodiments, General Formula (I) contains (exactly or at least) two R² substituents, which are preferably positioned at ring position 2 and 3. For example, p is 2 and R² is positioned at ring position 2 and 3. In other embodiments, General Formula (I) contains a single R² substituent only, which is preferably positioned at ring position 2 or 3. For example, p is 1 and R² is positioned at ring position 2; or p is 1 and R² is positioned at ring position 3.

In some embodiments, General Formula (I) comprises only R¹ (e.g., m=1 or 2), but no R² (p=0). In other embodiments, General Formula (I) comprises only R² (e.g., p=1), but no R¹ (m=0). In other embodiments, General Formula (I) comprises neither R¹ (m=0) nor R² (p=0) (phenazine). Preferably, General Formula (I) comprises at least one R¹ (e.g., m=1, 2 or 3) and at least one R² (e.g., p=1 or 2). More preferably, General Formula (I) comprises exactly two R¹ (m=2) and a single or exactly two R² (p=1 or 2).

In some embodiments, the first redox active compound may preferably comprise at least one —SO₃H/—SO₃⁻ group (e.g., as R¹ or R² in General Formula (I)).

In some embodiments, the first redox active compound may preferably comprise at least one hydroxyl group (e.g., as R¹ or R² in General Formula (I)). If more than one hydroxyl group is represented, they are preferably located at adjacent positions of the ring system.

In some embodiments, the first redox active compounds may comprise at least one alkyl group. In some embodiments, the first redox active compounds may comprise at least one alkyoxy (alkoxy) group. In some embodiments, the first redox active compounds may comprise at least one carboxyl group. In some embodiments, the first redox active compounds may comprise at least one amine group.

If R₂ is R_{c}, R_{c} can typically not be —H, as R₂ needs to be a substituent, i.e. a moiety other than —H. Thus, R₂ is preferably one of —OH, —SO₃H, alkyl, in particular methyl, and C(═O)OH. Alternatively, R₂ is preferably one of —OH, —SO₃H, and C(═O)OH or one of —SO₃H, and C(═O)OH. Also, p and m are typically defined such that they refer to the number of moieties other than —H, i.e. to the number of substituents replacing —H at the phenazine ring system, thereby resulting in the “substituted phenazine compound” as disclosed herein.

Preferably, the substituted phenazine compound of the present invention may be characterized by m being 1 and R₃ being identical with R₁, wherein R₁ and R₃ may preferably be positioned at positions 7 and 8. Alternatively, p may preferably be 0, m may preferably be 1, and R₁ and R₃ may more preferably be identical.

According to one embodiment, the substituted phenazine compound is defined by R₁, wherein R₁ may be selected from the group consisting of —OH, —ORₓ, —NH₂, —NHRₓ, —NRₓR_{y}, and —N(H)C(═O)Rₓ, wherein Rₓ and R_{y} may be selected from an unsubstituted or a substituted C₁₋₄ alkyl, preferably an unsubstituted or a substituted C₁₋₃ alkyl, more preferably an unsubstituted or a substituted methyl or unsubstituted or a substituted ethyl. The substituent of the alkyl chain may preferably be selected from the group consisting of —C(═O)OH, ═O, —SO₃H, —OH, substituted or unsubstituted phenyl, and —NH₂. The substituent R₁ may preferably be positioned at ring position 7 or 8. R₂ and R₃ may be as disclosed herein. More specifically, R₁ may be selected from —ORₓ, —NHRₓ, —N(H)C(═O)Rₓ and —NRₓR_{y},with Rₓ and R_{y} as defined herein.

Rₓ and R_{y} may also represent a substituted or unsubstituted C₁₋₄alkyl chain with one heteroatom replacing one carbon atom of its alkyl chain; the heteroatom may be selected from N, O and S. The substituents of the alkyl chain may be selected as defined above for R. and R_{y}.

According to a further embodiment, the substituted phenazine compound may be defined by R₁ being selected from the group consisting of —ORₓ, —NHRₓ, —NRₓR_{y} and —N(H)C(═O)Rₓ, preferably —ORₓ, —N(H)C(═O)Rₓ, and —NRₓR_{y}, more preferably —ORₓ and —NRₓR_{y} wherein Rₓ and R_{y} are selected from an unsubstituted or a substituted C₁₋₄ alkyl. Preferably, Rₓ and R_{y} may be defined by an unsubstituted or a substituted C₁₋₃ alkyl, more preferably an unsubstituted or a substituted methyl or unsubstituted or a substituted ethyl. The substituent may preferably be selected from the group consisting of —C(═O)OH, ═O, —SO₃H, —OH, substituted or unsubstituted phenyl, and —NH₂. Also, preferably, R₁ may be positioned at ring position 7 or 8. R₂ may be selected as disclosed herein.

R₂ may be selected for substituted phenazine compound of the present invention from the group consisting of —H, —OH, —SO₃H, C₁₋₄ alkyl, in particular methyl, and —C(═O)OH. At least one R₂ may preferably be selected from —SO₃H or —C(═O)OH, in particular —SO₃H, more preferably positioned at ring position 2 and/or 3.

According to another embodiment, the substituted phenazine compound may be characterized by R₁ being selected from —ORₓ, —NH₂, —NHRₓ, and —NRₓR_{y}. Rₓ and R_{y} may be selected from an unsubstituted or a substituted C₁₋₄ alkyl, preferably an unsubstituted or a substituted C₁₋₃ alkyl, more preferably an unsubstituted or a substituted methyl or an unsubstituted or substituted ethyl. The substituent may be selected from the group consisting of —C(═O)OH, —SO₃H, —OH, ═O, substituted or unsubstituted phenyl, and —NH₂. The phenazine ring substituent R₁ may be positioned at ring position 7 or 8. Thereby, p may be 1 or 2 and R₂ may be selected from methyl, —SO₃H or —C(═O)OH, preferably —SO₃H. In case p being 1, the substituent may be positioned at ring position 2 or 3, in case p being 2, the substituents may be positioned at ring positions 2 and 3 or 1 and 3.

According to another embodiment, the substituted phenazine compound defines for R₁—NRₓR_{y}, wherein Rₓ may be a substituted C₁₋₄alkyl, preferably methyl or ethyl. R_{y} may be an unsubstituted C₁₋₄alkyl, preferably methyl. Alternatively, the embodiment defines R₁, preferably at ring position 7 or 8, as being selected from —ORₓ, wherein Rₓ may be a substituted C₁₋₄ alkyl, preferably a substituted ethyl or C₃ alkyl. R₂ may be selected as disclosed herein.

Preferably, the substituted phenazine compound of the present invention may be characterized by one of the above defined substituents for R₁, which comprise Rₓ or R_{y}, in particular Rₓ, wherein Rₓ or R_{y} may be a substituted C₁₋₄ alkyl, wherein the substituent may be a terminal substituent. Alternatively or additionally, the Rₓ or R_{y}, in particular Rₓ, may be chosen such that a substituted C₁₋₄ alkyl may be characterized by a substituent being selected from —C(═O)OH and —SO₃H.

According to another embodiment, the substituted phenazine compound is characterized such that R₁ may be —N(H)C(═O)R_{X}, wherein R_{X} may preferably be selected from a substituted methyl or ethyl, in particular ethyl. The substituent may specifically be selected from —C(═O)OH and —SO₃H. It may also be foreseen that the substituent may preferably be a terminal substituent, i.e. a substituent located at the carbon atom of Rₓ being most distant from the phenazine ring system.

Preferably, the substituted phenazine compound of the present invention may exhibit for p 2, i.e. two R₂ are foreseen not being —H, wherein R₂ may be selected from —SO₃H and methyl.

More specifically, the first redox active compound preferably comprises (e.g., as R¹ or R² in General Formula (I)) a —SO₃H/—SO₃ group; and (e.g., as the other of R¹ or R² in General Formula (I)) at least one other substituent selected from the group consisting of an alkoxy group, e.g. methoxy group, a hydroxyl group and a carboxyl group. It is also preferred that, the first redox reactive compound may comprise by its substitution pattern: (i) (e.g., as R¹ or R² in General Formula (I)) at least one hydroxyl group, preferably two hydroxyl groups; and (ii) (e.g., as the other of R¹ or R² in General Formula (I)) at least one other substituent selected from the group consisting of an carboxyl group, a —SO₃H/—SO₃⁻ group, and an alkoxy group. In some embodiments, the first redox active compound comprises as substituents at least one alkoxy, e.g. methoxy group, and at least one hydroxyl group.

In other embodiments, the first redox active compound comprises as substituents at least one carboxyl group and at least one —SO₃H/—SO₃⁻ group. In still other embodiments, the first redox active compound comprises as substituents at least one —SO₃H/—SO₃⁻ group and at least one alkoxy, e.g. methoxy, group. In still other embodiments, the first redox active compound comprises as substituents at least one carboxyl and at least one hydroxyl group. In still further embodiments, the first redox active compound comprises as substituents at least one —SO₃H/—SO₃⁻ group, at least one hydroxyl and at least one methoxy group. In still further embodiments, the first redox active compound comprises as substituents at least one —SO₃H/—SO₃⁻ group, at least one hydroxyl and at least one carboxyl group. In still further embodiments, the first redox active compound comprises as substituents at least one alkoxy, e.g. methoxy, group, at least one hydroxyl and at least one carboxyl group. In still further embodiments, the first redox active compound comprises a methoxy, a hydroxyl and a —SO₃H/—SO₃⁻ group. Preferably, the first redox active compound comprises as substituents at least one —SO₃H/—SO₃⁻ group (e.g., as R¹ or R² in General Formula (I)) and at least one hydroxyl group (e.g., as the other of R¹ or R² in General Formula (I)).

In combination with at least one —SO₃H/—SO₃ group, it is also advantageous for the first redox active compound to comprise as substituents at least one alkyl group, e.g. a methyl group, specifically two alkyl groups. Any of the above embodiments comprising an —SO₃H/—SO₃ group (and at least one of a carboxyl group, hydroxyl group and/or alkoxy group) may thus also comprise at least one alkyl group, e.g. one or two alkyl groups, specifically one alkyl group.

Preferred first redox active compounds may be selected from the following compounds shown in any one of the following Structural Formulas (1.1)-(1.4) (or their reduced counterparts):

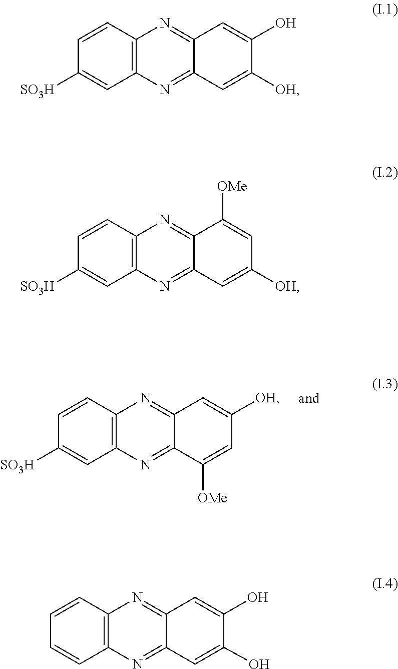 [SMILES: O=S(=O)(O)c1ccc2nc3cc(O)c(O)cc3nc2c1 ; COc1cc(O)cc2nc3cc(S(=O)(=O)O)ccc3nc12 ; COc1cc(O)cc2nc3ccc(S(=O)(=O)O)cc3nc12 ; "and" ; Oc1cc2nc3ccccc3nc2cc1O]

or any combination of two or more of the above.

Other preferred first redox active compounds (or their reduced counterparts) are shown in any one of the following Structural Formulas (1.5)-(1.7):

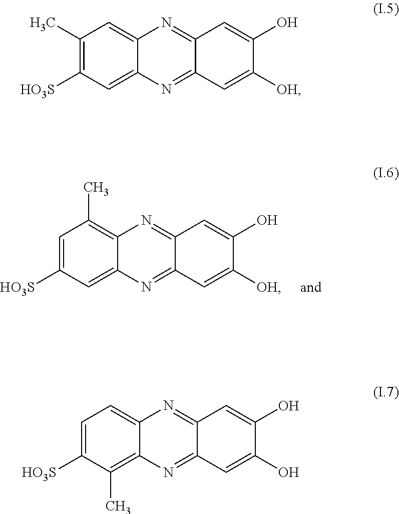 [SMILES: Cc1cc2nc3cc(O)c(O)cc3nc2cc1S(=O)(=O)O ; Cc1cc(S(=O)(=O)O)cc2nc3cc(O)c(O)cc3nc12 ; "and" ; Cc1c(S(=O)(=O)O)ccc2nc3cc(O)c(O)cc3nc12]

or any combination thereof, such as a combination of all of the above three compounds each having a methyl group at another position of the phenazine ring system.

Other preferred compounds (or their reduced counterparts) are shown in any one of the following Structural Formulas (1.8) and (1.9)

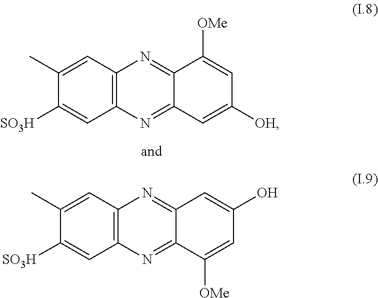 [SMILES: COc1cc(O)cc2nc3cc(S(=O)(=O)O)c(C)cc3nc12 ; COc1cc(O)cc2nc3cc(C)c(S(=O)(=O)O)cc3nc12]

or a combination thereof.

Further preferred compounds (or their reduced counterparts) are shown in any one of the following Structural Formulas (1.10) and (1.11):

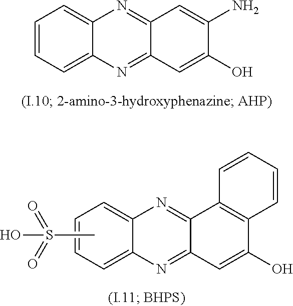

BHPS includes 5-hydroxybenzo[a]phenazine-9-sulfonic acid and 5-hydroxybenzo[a]phenazine-10-sulfonic acid.

Most preferably, the first redox active compound is

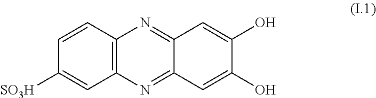 [SMILES: O=S(=O)(O)c1ccc2nc3cc(O)c(O)cc3nc2c1]

(7,8-dihydroxy phenazine-2-sulfonic acid; DHPS).

The first redox active compound may be in the reduced (General Formula (I)(a)) or oxidized state (General Formula (I)/(b)). The electrolyte composition of the present invention may comprise (at least one) compound according to Formula (l)(a) (reduced state) and (at least one) corresponding compound of Formula (I)(b) (oxidized state). In particular, the electrolyte composition of the present invention may comprise a redox pair of General Formula (I), i.e. a compound of General Formula (I)(a) and its corresponding reduced state, or a compound of General Formula (I)(b) and its corresponding oxidized state.

The first redox active compound may be a salt of a compound according to General Formula (I). In general, the compounds of General Formula (I) comprise acidic groups, which may be deprotonated under the alkaline conditions in a battery. In some embodiments, the salt may be an alkali salt. As used herein, the term “alkali salt” refers to any salt of an alkali metal. Alkali metals include lithium, sodium, potassium, rubidium, cesium and francium. Alkali salts usually exhibit a polar character and excellent solubility in water and aqueous solutions.

In some embodiments, the composition comprises at least two distinct first redox active compounds characterized by General Formula (I) as described herein. In this context, it is understood that the expression “at least two distinct first redox active compounds” does not refer to redox pairs (oxidized/reduced states of the same compound), but to compounds exhibiting distinct substitution patterns according to General Formula (I). Preferably, the inventive composition may comprise or (essentially) consist of a plurality of at least 2, 3, 4, 5 or more first redox active compounds, each of which may be present in its oxidized and/or reduced form. For example, the electrolyte composition may comprise at least 2, 3, 4, 5 or more distinct first redox active compounds as defined herein (characterized by General Formula (I)).

In other embodiments, the electrolyte composition according to the invention preferably comprises one single first redox active compound (or a single first redox pair) only.

### Second Redox Active Compound

The second redox active compound is distinct from the first redox active compound. Namely, the second redox active compound is not characterized by General Formula (I). Accordingly, the second redox active compound is not a phenazine or phenazine derivative (substituted phenazine). The second redox active compound may be selected from any redox active compound other than those of General Formula (I).

The second redox active compound may be an inorganic or an organic redox active compound. For example, the second redox active compound may be selected from the group consisting of inorganic ions (e.g., metal ions, halogen ions), metal complexes, polysulfide/sulfur systems, and metal-free organic compounds not according to General Formula (I).

In some embodiments, the second redox active compound may be an inorganic redox active compound, e.g. selected from inorganic ions (e.g., metal ions, halogen ions) and combinations thereof, metal complexes, or polysulfide/sulfur systems.

In some instances, the second redox active compound may be an inorganic ion or combinations of inorganic ions, such as a metal ion or a halogen ion, or a salt thereof, e.g. a metal salt. Metal ions provide a simple chemistry and high solubility for aqueous redox flow batteries. Halogen ions provide high solubility and relatively low molecular weight. Examples of halogen ions include bromine, chlorine and iodine. Metal ions include in particular transition metal ions. Examples of (transition) metal ions include iron, chromium, vanadium, titanium, copper, manganese. Non-limiting examples of inorganic ion redox species, which may be useful in redox flow batteries, include VCl₃/VCl₂, Br⁻/ClBr₂⁻, Cl₂/Cl⁻, Fe²⁺/Fe³⁺, Cr³⁺/Cr²⁺, Ti³⁺/Ti⁴⁺, V³⁺/V²⁺, VO₂⁺/VO²⁺, Zn/Zn²⁺, Br₂/Br⁻, Ce³⁺/Ce²⁺, Mn²⁺/Mn³⁺, I³⁻/I⁻, VBr₃/VBr₂, Cu/Cu¹⁺, Cu¹⁺/Cu²⁺, S/S²⁻, TiOH³⁺/Ti³⁺, and MnO₄/MnO₂. For example, the Fe²⁺/Fe³⁺ redox pair shows good reversibility and fast kinetics.

In some embodiments, the second redox active compound may be a metal complex. Metal complexes comprise a metal center and peripheral ligands. Preferably, the metal is a transition metal. The metal ion usually acts as charge transfer center, while distinct ligands may be used to tune the potential. Metal complexes may also comprise “redox-non-innocent ligands” (such as tris(mnt)vanadium, (mnt=(NC)₂C₂S₂²⁻)), wherein charges can also be stored in ligands, in addition to the metal center. Metal complexes usually exhibit a considerably larger size than the inorganic ions described above. The ligands in the metal complex may be selected such that the redox potential is tuned towards the positive or negative direction to meet the requirements of negolyte or posolyte, respectively. Examples of metals in metal complexes include, but are not limited to, iron, cobalt, vanadium, cerium, chromium, manganese, nickel, and ruthenium (each may be combined with various ligands). Examples of ligands in metal complexes include, but are not limited to, ethylenediaminetetraacetate (EDTA), phenanthroline, triethanolamine, diethylenetriaminepentaacetic acid (DTPA), tris(2,2′-bipyridine) and acetylacetonate. Specific examples of metal complexes include tris(2,2′-bipyridine)ruthenium(II) ([Ru(bpy)₃]²⁺)/[Ru(bpy)₃]³⁺ and [Ru(bpy)₃]⁺/[Ru(bpy)₃]²⁺; tris(2,2′-bipyridine)iron, tris(2,2′-bipyridine)nickel, vanadium acetylacetonate (V(acac)₃), chromium acetylacetonate (Cr(acac)₃) and manganese acetylacetonate (Mn(acac)₃). Further examples include hexacyanoiron complexes, e.g. ferrocyanide.

In some embodiments, the metal complex may be a metallocene or metallocene derivative. A metallocene is typically composed of a metal center (e.g., a transition metal center), sandwiched by two cyclopentadienyl anions (C₅H₅⁻, abbreviated Cp), with the resulting general formula (C₅H₅)₂M. Closely related to the metallocenes are the metallocene derivatives, e.g. titanocene dichloride, vanadocene dichloride. Some metallocenes are composed of metal plus two cyclooctatetraenide anions (C₃H₃²⁻, abbreviated cot²⁻), namely the lanthanocenes and the actinocenes (uranocene and the like). Metallocenes are usually stable and robust. Examples include ferrocene derivatives (e.g., bromoferrocene, ferrocenylmethyl dimethyl ethyl ammonium bis(trifluoromethanesulfonyl)imide) and cobaltocene derivatives (e.g., bis(pentamethylcyclopentadienyl)cobalt).

In some embodiments, the second redox active compound may be polysulfide/sulfur systems. Sulfur provides high theoretical capacity, non-toxicity and low costs. Examples include NaS and (long chain) polysulfides. NaS is abundant and cost effective and exhibits high solubility in aqueous solvents.

Preferably, the second redox active compound may be an organic compound, which is not according to General Formula (I). The organic compound may be metal-free. Metal-free organic compounds do not require any redox-active metals (which may be scarce and/or expensive) and provide the advantage of natural abundance, potential and solubility tunability and eco-friendliness. Organic compounds useful as redox active compounds, e.g. in redox-flow batteries, include, but are not limited to, quinones (including naphthaquinones and anthraquinones) and derivatives thereof, organic dyes such as indigo carmine, viologen, methyl viologen or benzylviologen, tetrazole, diaryl ketone, dipyridyl ketone, dialkoxy benzene, phenothiazine, catechol, catechol ether, catechol phenylborate ester, and in particular tetrafluorocatechol, 5-mercapto-1-methyltetrazoledi-(2-pyridyl)-ketone, as well as further compounds based on aromatic molecules, such as 2,5-di-tert-Butyl-1,4-bis(2-methoxyethoxy)benzene (DBBB/DBBB⁺), 3,7-bis(trifluoromethyl)-N-ethylphenothiazine (BCF₃EPT/BCF₃EPT), 9-fluorenone, 2,5-di-tert-butyl-1,4-dimethoxybenzene, 2,5-di-tert-butyl-1-methoxy-4-[2′-methoxyethoxy]benzene (DBMMB), 2,5-di-tert-butyl-1,4-bis(2,2,2-trifluoroethoxy)benzene, 5,6,7,8-tetrafluoro-2,3-dihydrobenzodioxine and 2,2,6,6-Tetramethylpiperidine-1-oxyl (TEMPO) and derivatives thereof, such as 4-Methoxy-2,2,6,6-tetra-methylpiperidine-1-oxyl (Meo-TEMPO), or salts thereof.

More preferably, the second redox active compound is a quinone (including naphthaquinones and anthraquinones) or a derivative thereof (substituted quinone); or a salt, in particular an alkali salt, of a (substituted) quinone. Quinone compounds are advantageously capable of undergoing reversible and fast electrochemical transformations between their oxidized (quinone) and reduced (hydroquinone) forms. Quinone/hydroquinone redox couples are particularly suitable for redox flow battery applications, as their rapid redox cycling characteristics enable high battery discharge and charge rates.

As used herein (i.e. throughout the present specification), the term “quinone” refers to a class of cyclic organic compounds that include fully conjugated —C(═O)— groups and carbon-carbon double bonds. In one example, the term “quinone” refers to organic compounds that are formally derived from aromatic compounds by replacement of an even number of —CH═ groups with —C(═O)— groups with the double bonds rearranged as necessary to provide a fully conjugated cyclic dione, tetra-one, or hexa-one structure. The term inter alia covers substituted and unsubstituted quinones derived from mono-, di- and trihydroaromatic systems comprising 1 to 3 fused carbon cyclic rings in their oxidized and reduced forms.

Preferably, the second redox active compound is characterized by any one of General Formulas (II) to (IV):

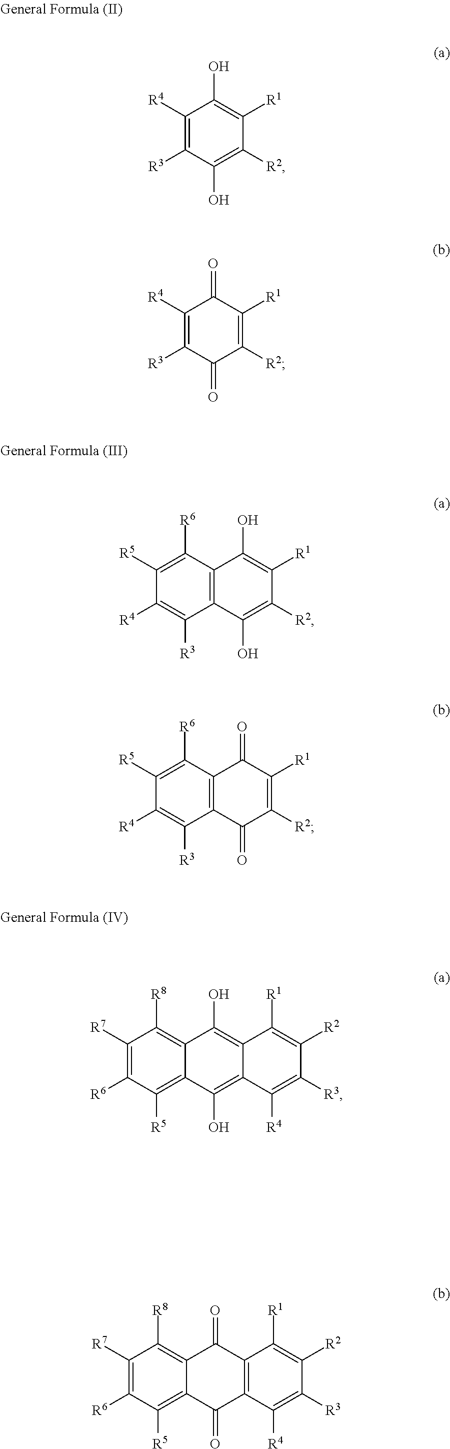

wherein
each of R¹-R⁴ in General Formula (II); R¹-R⁶ in General Formula (III); and/or R¹-R⁸ in General Formula (IV) is independently selected from hydrogen; hydroxyl; carboxy; optionally substituted C₁₋₆alkyl optionally comprising at least one heteroatom selected from N, O and S, including —CₙH₂ₙOH, —CₙH₂ₙNH₂ and —CₙH₂ₙSO₃H, wherein n is an integer selected from 1, 2, 3, 4, 5, or 6; carboxylic acids; esters; halogen; optionally substituted C₁₋₆ alkoxy, including methoxy and ethoxy; optionally substituted amino, including primary, secondary, tertiary and quaternary amines; amide; nitro; carbonyl; phosphoryl; phosphonyl; cyanide; and sulfonyl (—SO₃H);
or an alkali salt thereof.

In general, alkyl and alkoxy groups, in particular C₁₋₆ alkyl and alkoxy groups disclosed in the context of General Formulas (I), (II) and (Ill) herein, may be linear or branched, and optionally substituted or unsubstituted.

Preferably, the compounds of General Formula (II), (Ill) and (IV) may be classified as “quinone compound”, which may be present in their oxidized (b; quinone) or reduced (a; hydroquinone) forms or both, forming a quinone/hydroquinone redox pair. The term “quinone compound” is thus inclusive and refers to oxidized (quinone) and reduced (hydroquinone) forms of the same compound.

In some embodiments, at least one of R¹-R⁴ in formula (II); R¹-R⁶ in formula (III); and/or R¹-R⁸ in formula (IV) is selected from —SO₃H; —CₙH₂ₙSO₃H optionally comprising at least one heteroatom selected from N, O and S, wherein n is an integer selected from 1, 2, 3, 4, 5, or 6; and optionally substituted C₁₋₆ alkoxy, preferably methoxy.

More preferably, at least one of R¹-R⁴ in formula (II); R¹-R⁶ in formula (III); and/or R¹-R⁸ in formula (IV) is a hydroxyl group, even more preferably two of R¹-R⁴ in formula (II); R¹-R⁶ in formula (III); and/or R¹-R⁸ in formula (IV) are hydroxyl groups. The remaining R¹-R⁴ in formula (II); R¹-R⁶ in formula (III); and/or R¹-R⁸ in formula (IV) may be hydrogen. Accordingly, the second redox active compound is preferably an aromatic alcohol. More preferably, the second redox active compound is a hydroxyquinone, a hydroxynaphthoquinone or a hydroxyanthraquinone. Even more preferably, the second redox active compound is a dihydroxyquinone, a dihydroxynaphthoquinone or a dihydroxyanthraquinone.

While unsubstituted quinone may exhibit a limited solubility in water, water solubility may be enhanced by attaching polar groups such as ether, polyether, ester, sulfonyl or hydroxyl groups. Examples of such functional groups include, but are not limited to, —SO₃H/SO₃, —PO₃H₂/—PO₃H⁻/—PO₃²⁻, —COOH/—COO⁻, —OH/—O⁻, pyridinyl, imidazoyl, —NH₂/NH₃₊, NHR/NH₂R⁺, NR₂/NHR²⁺ and NR³⁺, wherein R is H or C₁₋₁₀ alkyl.

Stability is important not only to prevent chemical loss for long cycle life, but also because polymerization on the electrode can compromise the electrode's effectiveness. Stability against water and polymerization may be enhanced by replacing C—H groups (in particular those adjacent to C═O groups) with stable groups, e.g. selected from optionally substituted C₁₋₆ alkyl, optionally substituted C₁₋₆ alkoxy, hydroxyl, sulfonyl, amino, nitro, carboxyl, phosphoryl or phosphonyl.

Redox kinetics may be altered by adding electron-withdrawing groups (in order to preferably increase the standard reduction potential of the resulting substituted compound) or electron-donating groups (in order to preferably lower the standard reduction potential of the resulting substituted compound). Electron-withdrawing groups may be selected from —SO₃H/—SO₃⁻, —OH/—O⁻, —COR, —COOR, —NO₂, —NR₃⁺, —CF₃, —CCl₃, —CN, —PO₃H₂/—PO₃H⁻/—PO₃²⁻, —COOH/—COO⁻, —F, —Cl, —Br, —CHO, where R is H or C₁₋₁₀ alkyl. Electron-withdrawing groups may advantageously be introduced into quinone compounds in order to increase their standard reduction potential. Electron-donating groups may be selected from C₁₋₆ alkyl, including methyl (—CH₃), ethyl (—C₂H₅), or phenyl, —NH₂, —NHR, —NR₂, —NHCOR, —OR, where R is H or C₁₋₁₀ alkyl. Electron-donating groups may advantageously be introduced into quinone compounds in order to lower their standard reduction potential.

Preferably, quinone compounds may be highly soluble in water, chemically stable in strongly acidic/basic solutions, and, when used in redox flow batteries, capable of providing high cell voltages of about 1 V, round-trip efficiencies >80%, and high discharge rates. Accordingly, preferred quinone compounds may comprise electron-withdrawing or electron-donating groups for increasing or lowering the standard reduction potential (depending on whether the resulting composition is envisaged for use as a posolyte or negolyte, respectively) and optionally further substituents increasing their solubility in water as described herein. In general, the said quinone compounds may comprise these substituents in any suitable combination.

Preferably, the quinone compound is according to General Formula (II) or an alkali salt thereof. In quinone compounds according to General Formula (II), R¹ may be selected from —H, —SO₃H, and optionally substituted C₁₋₆ alkyl; R² may be selected from —H, —OH, —SO₃H and C₁₋₆ alkoxy, preferably methoxy; R³ may be selected from —H, —OH and C₁₋₆ alkoxy, preferably methoxy; and R⁴ may be selected from —H, —SO₃H, —C₁₋₆ alkyl and halogen.

More preferably, in quinone compounds according to General Formula (II), R¹ and/or R⁴ may be independently selected from substituted C₁₋₆ alkyl selected from —R⁵—SO₃H and —R⁵—CO₂H, wherein R⁵ is C₁₋₆ alkyl optionally comprising at least one heteroatom selected from N, O or S.

In particular, quinone compounds of General Formula (II) may be characterized by any one of the following Structural Formulas (11.1)-(11.8) (or the corresponding quinone forms thereof):

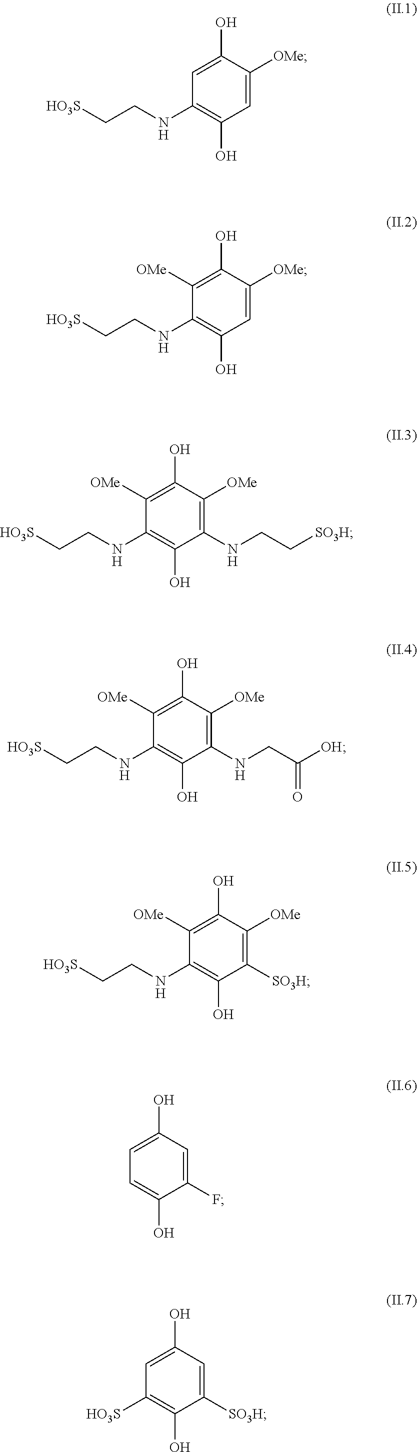

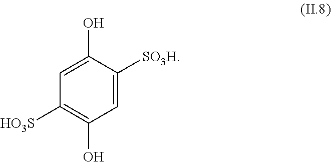

In general, the second redox active compound may be in the reduced or oxidized state. Accordingly, the electrolyte composition of the present invention may comprise (at least one) compound according to Formula (II)(a) (reduced state) and (at least one) corresponding compound of Formula (II)(b) (oxidized state). In particular, the electrolyte composition of the present invention may comprise a redox pair of General Formula (II), i.e. a compound of General Formula (II)(a) and its corresponding reduced state, or a compound of General Formula (II)(b) and its corresponding oxidized state.

Preferably, the quinone compound is according to General Formula (III) or an alkali salt or a derivative thereof. In quinone compounds according to General Formula (III), R¹ and R² may be independently selected from —H, —OH and C₁₋₆ alkoxy, preferably methoxy; and R³-R⁶ may be independently selected from —H and —SO₃H.

A preferred quinone compound of General Formula (III) is Lawsone (2-hydroxy-1,4-naphthoquinone), which is characterized by the following Structural Formula (III.1) (or a hydroquinone form thereof), or a salt or derivative thereof:

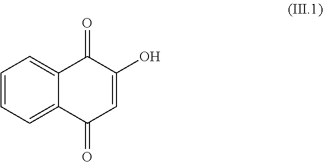

A particularly preferred derivative of Lawsone is Bislawsone (a dimer of Lawsone), which is characterized by the following Structural Formula (III.2) (or a hydroquinone form thereof), or a salt thereof:

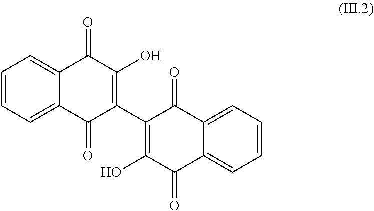 [SMILES: O=C1C(O)=C(C2=C(O)C(=O)c3ccccc3C2=O)C(=O)c2ccccc21]

Accordingly, Lawsone and Bislawsone (or salts thereof) are preferred.

In general, the second redox active compound may be in the reduced or oxidized state. Accordingly, the electrolyte composition of the present invention may comprise (at least one) compound according to Formula (III)(a) (reduced state) and (at least one) corresponding compound of Formula (III)(b) (oxidized state). In particular, the electrolyte composition of the present invention may comprise a redox pair of General Formula (III), i.e. a compound of General Formula (III)(a) and its corresponding reduced state, or a compound of General Formula (III)(b) and its corresponding oxidized state.

Particularly preferably, the second redox active compound is a (substituted) anthraquinone or an alkali salt thereof. Accordingly, it is more preferred that the second redox active compound is characterized by General Formula (IV).

In some embodiments, in quinone compounds according to General Formula (IV), R¹, R² and R⁴ may be independently selected from —H, —OH and C₁₋₆ alkoxy, preferably methoxy; and R³ and R⁵-R⁸ may be independently selected from —H and —SO₃H. More preferably, in quinone compounds according to General Formula (IV), R¹ may be —SO₃H; R² may be —SO₃H and R¹, R³ and R⁴ may preferably be —OH; R⁶ may be —SO₃H, R¹ and R⁴ or R¹, R² and R⁴ may preferably be —OH; R² and R⁶ may be —SO₃H, R¹ and R⁴ or R¹, R³ and R⁴ may preferably be —OH; R³ and R⁶ may be —SO₃H; R¹, R² and R⁴ may preferably be —OH; R² and R⁷ may be —SO₃H; or R¹ and R⁴ are —SO₃H; wherein each of the others of R¹-R⁸ may be C₁₋₆ alkoxy or —H, preferably —H.

More preferably, in quinone compounds according to General Formula (IV), R¹-R⁸ may be independently selected from —H, —OH, —SO₃H, —C₁₋₆(alkyl)-OH, —C₁₋₆(alkyl)-CO₂H, C₁₋₆(alkyl)—SO₃H, —O—C₁₋₆(alkyl)-OH, —O—C₁₋₆(alkyl)—COOH, and —O—C₁₋₆(alkyl)—SO₃H.

In quinone compounds according to General Formula (IV), preferably at least four of R¹-R⁸ may be —H. It is also preferred that no more than six of R¹-R⁸ may be —H. In other words, it is preferred that at least two and no more than four of R¹-R⁸ may be substituents other than —H. In some embodiments, in General Formula (IV) four of R¹-R⁸ may be —H and four of R¹-R⁸ may be substituents other than —H. In some embodiments, in General Formula (IV) five of R¹-R⁸ may be —H and three of R¹-R⁸ may be substituents other than —H. In some embodiments, in General Formula (IV) six of R¹-R⁸ may be —H and two of R¹-R⁸ may be substituents other than —H.

Even more preferably, in quinone compounds according to General Formula (IV) at least two of R¹-R⁸ may be selected from OH, —O—C₁₆(alkyl)-OH, —O—C₁₆(alkyl)-CO₂H, and —O—C₁₆(alkyl)—SO₃H.

In some embodiments, at least one of R¹-R⁸ in General Formula (IV) is selected from —SO₃H; —CₙH₂ₙSO₃H optionally comprising at least one heteroatom selected from N, O and S, wherein n is an integer selected from 1, 2, 3, 4, 5, or 6; and optionally substituted C₁₋₆ alkoxy, preferably methoxy.

More preferably, at least one of R¹-R⁸ in formula (IV) is a hydroxyl group, even more preferably two of R¹-R⁸ in formula (IV) are hydroxyl groups. The remaining of R¹-R⁸ in formula (IV) may be hydrogens. Accordingly, the second redox active compound is preferably a hydroxyanthraquinone. Even more preferably, the second redox active compound is a dihydroxyanthraquinone, such as 2,6-dihydroxyanthraquinone.

In some embodiments, quinone compounds may be characterized by Structural Formula (IV.1) or a hydroquinone form thereof:

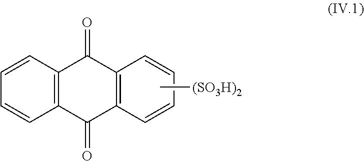

Preferred quinone compounds of General Formula (IV) may be characterized by any one of the Structural Formulas (IV.1)-(IV.5) (or the corresponding hydroquinone forms thereof), or a salt thereof:

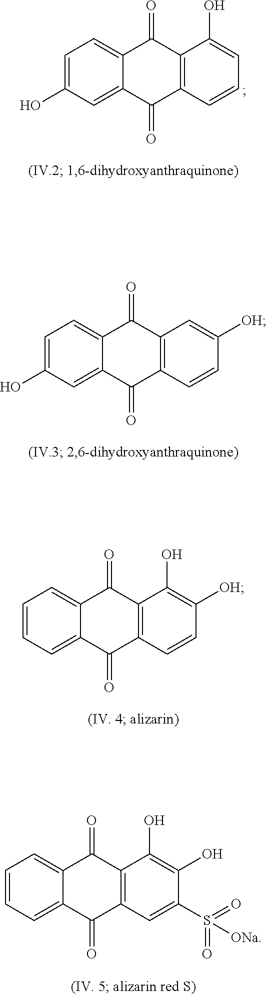

Further preferred quinone compounds include, but are not limited to, 1,4-benzoquinone-2,5-disulfonic acid, 1,4-benzoquinone-2,6-disulfonic acid, 1,4-benzoquinone-2-sulfonic acid, 1,4-naphthoquinone-2,6-disulfonic acid, 1,4-naphthoquinone-2,7-disulfonic acid, 1,4-naphthoquinone-5,7-disulfonic acid, 1,4-naphthoquinone-5-sulfonic acid, 1,4-naphthoquinone-2-sulfonic acid, 9,10-anthraquinone-2,6-disulfonic acid, 9,10-anthraquinone-2,7-disulfonic acid, 9,10-anthraquinone-1,5-disulfonic acid, 9,10-anthraquinone-1-sulfonic acid and 9,10-anthraquinone-2-sulfonic acid, or hydroquinone forms thereof.

Particularly preferred anthraquinone compounds include alizarin, alizarin red S hydroxyanthraquinone and dihydroxyanthraquinone. More preferably, the second redox active compound of General Formula (IV) is 1,6-dihydroxyanthraquinone, 2,6-dihydroxyanthraquinone, alizarin or alizarin red S. Even more preferably, the second redox active compound of General Formula (IV) is 2,6-dihydroxyanthraquinone, alizarin or alizarin red S. Most preferably, the second redox active compound of General Formula (IV) is 2,6-dihydroxyanthraquinone or alizarin.

In general, the second redox active compound may be in the reduced or oxidized state. Accordingly, the electrolyte composition of the present invention may comprise (at least one) compound according to Formula (IV)(a) (reduced state) and (at least one) corresponding compound of Formula (IV)(b) (oxidized state). In particular, the electrolyte composition of the present invention may comprise a redox pair of General Formula (IV), i.e. a compound of General Formula (IV)(a) and its corresponding reduced state, or a compound of General Formula (IV)(b) and its corresponding oxidized state.

Among the above described quinone compounds 2,6-dihydroxyanthraquinone, lawsone, bislawsone, alizarin and alizarin red S are particularly preferred.

In some embodiments, the electrolyte composition comprises at least two distinct second redox active compounds. Preferably, the inventive composition may comprise or (essentially) consist of a plurality of at least 2, 3, 4, 5 or more second redox active compounds, each of which may be present in its oxidized and/or reduced form. For example, the electrolyte composition may comprise at least 2, 3, 4, 5 or more distinct second redox active compounds as defined herein. In particular, it is preferred that the electrolyte composition comprises at least two distinct redox active compounds characterized by any one of General Formulas (II) to (IV) as defined herein, or alkali salts thereof. In this context, it is understood that the expression “at least two distinct redox active compounds” does not refer to redox pairs (oxidized/reduced states of the same compound), but to compounds exhibiting distinct substitution patterns according to General Formulas (II), (Ill) or (IV). In some embodiments, the electrolyte composition may comprise at least two distinct compounds according to General Formula (II), or alkali salts thereof. In some embodiments, the electrolyte composition may comprise at least two distinct compounds according to General Formula (III), or alkali salts thereof. In some embodiments, the electrolyte composition may comprise at least two distinct compounds according to General Formula (IV), or alkali salts thereof. In some embodiments, the electrolyte composition may comprise a compound according to General Formula (II), or an alkali salt thereof, and a compound according to General Formula (III), or an alkali salt thereof. In some embodiments, the electrolyte composition may comprise a compound according to General Formula (II), or an alkali salt thereof, and a compound according to General Formula (IV), or an alkali salt thereof. In some embodiments, the electrolyte composition may comprise a compound according to General Formula (III), or an alkali salt thereof, and a compound according to General Formula (IV), or an alkali salt thereof.

In other embodiments, the electrolyte composition according to the invention preferably comprises one single second redox active compound (or a single second redox pair) only.

As used herein, the term “alkali salt” refers to any salt of an alkali metal. Alkali metals include lithium, sodium, potassium, rubidium, cesium and francium. Alkali salts usually exhibit a polar character and excellent solubility in water and aqueous solutions.

In some embodiments, the electrolyte composition of the invention does not comprise lithium or a lithium salt. In some embodiments, the electrolyte composition of the invention does not comprise a compound comprising lithium.

### Solvent

In addition to the first redox active compound and the second redox active compound, the electrolyte composition of the invention further comprises a solvent. The first and second redox active compound is usually dissolved or suspended in a suitable solvent, such as water.

Solvents known in the battery art include, for example, organic carbonates (e.g., ethylene carbonate (EC), propylene carbonate (PC), dimethyl carbonate (DMC), diethyl carbonate (DEC), ethyl methyl carbonate (EMC), and the like, or mixtures thereof), ethers (e.g., diethyl ether, tetrahydrofuran, 2-methyl tetrahydrofuran, dimethoxyethane, and 1,3 dioxolane), esters (e.g., methyl formate, gamma-butyrolactone, and methyl acetate), and nitriles (e.g., acetonitrile).

Particularly suitable solvents for dissolving or suspending the first and second redox active compounds include, without limitation, water, ionic liquids, methanol, ethanol, propanol, isopropanol, acetonitrile, acetone, dimethylsulfoxide, glycol, carbonates such as propylenecarbonate, ethylene carbonate, propylene carbonate, dimethyl carbonate, diethyl carbonate, methyl ethyl carbonate, propylene carbonate; polyethers such as dimethoxyethane; gamma-butyrolactone tetrahydrofuran; dioxolane; sulfolane; dimethylformamide; diethylformamide; CO₂ and supercritical CO₂; or a mixture thereof.

Preferably, the first and second redox active compounds may be dissolved or suspended in aqueous solution, e.g. an aqueous solvent system, thereby forming an electrolyte composition. Accordingly, the electrolyte composition of the invention is preferably an aqueous composition. In other words, the electrolyte composition of the invention preferably comprises water. Optionally, the electrolyte composition of the invention may comprise a (co-)solvent (in addition to water).

As used herein, the term “aqueous solvent system” refers to a solvent system comprising preferably at least about 20% by weight of water, relative to total weight of the solvent. An aqueous composition comprises an aqueous solvent system. In particular, any solvent system of an aqueous composition is an aqueous solvent system as described herein. In some applications, soluble, miscible, or partially miscible (emulsified with surfactants or otherwise) co-solvents may also be usefully present which, for example, extend the range of water's liquidity (e.g., alcohols/glycols). In addition to the redox active compounds described herein, the electrolyte composition may contain additional buffering agents, supporting electrolytes, viscosity modifiers, wetting agents, and the like, which may be part of the solvent system.

The term “aqueous solvent system” thus includes solvents comprising at least about 40%, at least about 50 wt %, at least about 60 wt %, at least about 70 wt %, at least about 75 wt %, at least about 80%, at least about 85 wt %, at least about 90 wt %, at least about 95 wt %, or at least about 98 wt % water, relative to the total solvent. For the purpose of this calculation, any co-solvents are included in the weight of the solvent but any type of redox active compound, buffer, or other non-solvent compound is not considered a solvent, even if such species is a liquid. When a co-solvent is present, the co-solvent may be soluble, miscible, or partially miscible with water. In some embodiments, the aqueous solvent may consist essentially of water, and be substantially free or entirely free of co-solvents or other (non-redox active) compounds. The solvent system may be at least about 90 wt %, at least about 95 wt %, or at least about 98 wt % water, or may be free of any co-solvents or other (non-redox active) compounds.

In particular, the “aqueous solvent system” may include solvents comprising at least 40%, at least 50 wt %, at least 60 wt %, at least 70 wt %, at least 75 wt %, at least 80%, at least 85 wt %, at least 90 wt %, at least 95 wt %, or at least 98 wt % water, relative to the total solvent.

Sometimes, the aqueous solvent may consist essentially of water, and be substantially free or entirely free of co-solvents or other (non-target compound) species. The solvent system may be at least about 90 wt %, at least about 95 wt %, or at least about 98 wt % water, or may be free of co-solvents or other (non-target compound) species.

Preferably, the electrolyte composition according to the present invention comprises an organic solvent, in particular an organic water-miscible solvent. More preferably, the organic solvent is selected from the group consisting of dimethyl sulfoxide, anisole, 1,4-dioxane, ethylene glycol, glycerol, tetrahydrofuran, diethylene glycol, triethylene glycol, dimethoxyethane, bis(2-methoxyethyl)ether, triethylene glycol dimethyl ether, a fatty alcohol ethoxylate having a C₁₂-C₁₈ chain and an ethoxylation degree of 2-30, and a monoalcohol of General Formula (V):

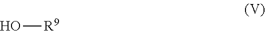

wherein R⁹ is a saturated or partially unsaturated, linear or branched C₁-C₁₈ alkyl chain, or a condensed or annulated aromatic moiety having 6-14 carbon atoms.

More preferably, the organic solvent is selected from the group consisting of dimethyl sulfoxide, ethylene glycol, glycerol, and a monoalcohol of General Formula (V):

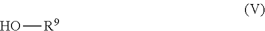

wherein R⁹ is a saturated or partially unsaturated, linear or branched C₁-C₅ alkyl chain.

In some embodiments, the solvent may be selected from water, methanol, ethanol, dimethylsulfoxide, acetonitrile, acetone and glycol.

Preferably, the amount of the organic (water-miscible) solvent is 0.1 to 50 wt %, preferably 1 to 30 wt %, more preferably 2 to 20 wt %, relative to the total amount of the solvent. As described above, for the purpose of this calculation, any co-solvents are included in the weight of the solvent but any type of redox active compound, buffer, or other non-solvent compound is not considered a solvent, even if such species is a liquid.

### Further Features of the Electrolyte Composition

As described above, the electrolyte composition of the present invention comprises at least one first redox reactive compound, e.g. 1, 2, 3, 4, 5 or more first redox reactive compound(s), as described above, and at least one second redox reactive compound, e.g. 1, 2, 3, 4, 5 or more second redox reactive compound(s), as described above. Preferably, the electrolyte composition comprises a single first redox active compound (a single first redox pair) and a single second redox active compound (a single second redox active pair). In some embodiments, the electrolyte composition may comprise a single first redox active compound (a single first redox pair) and two or three second redox active compounds (two or three second redox active pairs). In other embodiments, the electrolyte composition may comprise two or three first redox active compounds (two or three first redox active pairs) and a single second redox active compound (a single second redox pair). In still other embodiments, the electrolyte composition may comprise two or three first redox active compounds (two or three first redox active pairs) and two or three second redox active compounds (two or three second redox active pairs). In some instances, the electrolyte composition may not comprise any redox active compound other than the first and second redox active compound as described above.

In some embodiments, the electrolyte composition of the present invention comprises (i) a first redox active compound according to General Formula (I) (or a salt thereof as described herein) and (ii) a quinone compound as a second redox active compound, such as a compound according to General Formula (III) or (IV) (or a salt thereof as described herein).

More preferably, the electrolyte composition of the present invention comprises (i) 7,8-dihydroxy phenazine-2-sulfonic acid (DHPS; or a salt thereof as described herein) and (ii) a quinone compound as a second redox active compound, such as a compound according to General Formula (III) or (IV) (or a salt thereof as described herein). It is also more preferred that the electrolyte composition of the present invention comprises (i) a first redox active compound according to General Formula (I) (or a salt thereof as described herein) and (ii) a quinone compound selected from the group consisting of a -dihydroxyanthraquinone (preferably 1,6- or 2,6-dihydroxyanthraquinone), lawsone, bislawsone, alizarin and alizarin red S (or a salt thereof as described herein).

Particularly preferably, the electrolyte composition of the present invention comprises (i) 7,8-dihydroxy phenazine-2-sulfonic acid (or a salt thereof as described herein) and (ii) dihydroxyanthraquinone (preferably 1,6- or 2,6-dihydroxyanthraquinone) (or a salt thereof as described herein). It is also particularly preferred, that the electrolyte composition of the present invention comprises (i) 7,8-dihydroxy phenazine-2-sulfonic acid (or a salt thereof as described herein) and (ii) lawsone (or a salt thereof as described herein). It is also particularly preferred, that the electrolyte composition of the present invention comprises (i) 7,8-dihydroxy phenazine-2-sulfonic acid (or a salt thereof as described herein) and (ii) bislawsone (or a salt thereof as described herein). It is also particularly preferred, that the electrolyte composition of the present invention comprises (i) 7,8-dihydroxy phenazine-2-sulfonic acid (or a salt thereof as described herein) and (ii) alizarin (or a salt thereof as described herein). It is also particularly preferred, that the electrolyte composition of the present invention comprises (i) 7,8-dihydroxy phenazine-2-sulfonic acid (or a salt thereof as described herein) and (ii) alizarin red S.

In some embodiments, the electrolyte composition does not comprise a further redox active compound in addition to the above-described (single) first redox pair and (single) second redox pair. For example, the electrolyte composition may comprise (i) a single first redox active compound (a single first redox pair; e.g., 7,8-dihydroxy phenazine-2-sulfonic acid (or a salt thereof as described herein)) and (ii) a single second redox active compound (a single second redox active pair; e.g. selected from the group consisting of a dihydroxyanthraquinone (preferably 1,6- or 2,6-dihydroxyanthraquinone), lawsone, bislawsone, alizarin and alizarin red S (or a salt thereof as described herein), but no further redox active compounds.

Preferably, the electrolyte composition of the invention comprises at least 0.05 M, e.g. at least 0.1 M or at least 0.15 M; preferably at least 0.2 M, e.g., at least 0.25 M; more preferably at least 0.3 M; even more preferably at least 0.35 M; still more preferably at least 0.4 M of the first redox active compound (according to General Formula (I)). These values refer in particular to the total molarity of all first redox active compounds (according to General Formula (I)) present in the electrolyte composition of the invention.

Preferably, the electrolyte composition of the invention comprises at most 5 M, e.g., at most 4.5 M; preferably at most 4 M, e.g., at most 4.5 M; more preferably at most 3 M, e.g. at most 2.5 M; even more preferably at most 2 M; e.g. at most 1.75 M; and still more preferably at most 1.5 M of the first redox active compound (according to General Formula (I)). These values refer in particular to the total molarity of all first redox active compounds (according to General Formula (I)) present in the electrolyte composition of the invention.

Moreover, it is preferred that the electrolyte composition according to the present invention contains about 0.05 to 3 M, preferably about 0.2 to 3 M, more preferably about 0.3 to 2 M, even more preferably about 0.4 to 1.5 M, of the first redox active compound (according to General Formula (I)). This means in particular, that the total molarity of all first redox active compounds (according to General Formula (I)) present in the electrolyte composition of the invention is about 0.05 M to 3 M, preferably about 0.2 to 3 M, more preferably about 0.3 to 2 M, even more preferably about 0.4 to 1.5 M.

In some embodiments, the electrolyte composition according to the present invention contains about 0.01 to 1 M, preferably about 0.05 to 0.75 M, more preferably about 0.09 to 0.5 M, even more preferably about 0.1 to 0.4 M, of the first redox active compound (according to General Formula (I)). This means in particular, that the total molarity of all first redox active compounds (according to General Formula (I)) present in the electrolyte composition of the invention is about 0.01 M to 1 M, preferably about 0.05 to 0.75 M, more preferably about 0.09 to 0.5 M, even more preferably about 0.1 to 0.4 M.

Preferably, the electrolyte composition of the invention comprises at least 0.01 M, e.g., at least 0.02 M; preferably at least 0.03 M, e.g., at least 0.04 M; more preferably at least 0.05 M, e.g. at least 0.06 M; even more preferably at least 0.07 M; e.g. at least 0.08 M; and still more preferably at least 0.09 M, e.g. 0.1 M of the second redox active compound (not according to General Formula (1)). These values refer in particular to the total molarity of all second redox active compounds (not according to General Formula (I)) present in the electrolyte composition of the invention.

Preferably, the electrolyte composition of the invention comprises at most 5 M, e.g., at most 4 M; preferably at most 3 M, e.g., at most 2 M; more preferably at most 1.75 M, e.g. at most 1.5 M; even more preferably at most 1.25 M; e.g. at most 1.0 M; and still more preferably at most 0.7 M of the second redox active compound (not according to General Formula (I)). These values refer in particular to the total molarity of all second redox active compounds (not according to General Formula (I))present in the electrolyte composition of the invention.

The electrolyte composition according to the present invention preferably contains about 0.02 to 1.5 M, preferably about 0.035 to 1 M, more preferably about 0.05 to 0.7 M, of the second redox active compound (not according to General Formula (I)). This means in particular, that the total molarity of all second redox active compounds (not according to General Formula (I)) present in the electrolyte composition of the invention is about 0.02 to 1.5 M, preferably about 0.035 to 1 M, more preferably about 0.05 to 0.7 M.

In some embodiments, the electrolyte composition according to the present invention contains about 0.01 to 1 M, preferably about 0.02 to 0.5 M, more preferably about 0.03 to 0.1 M, of the second redox active compound (not according to General Formula (I)). This means in particular, that the total molarity of all second redox active compounds (not according to General Formula (I)) present in the electrolyte composition of the invention is about 0.01 to 1 M, preferably about 0.02 to 0.5 M, more preferably about 0.03 to 0.1 M.

With regard to molarity, the molarity of the first redox active compound in the electrolyte composition may be the same or higher than the molarity of the second redox active compound in the electrolyte composition. Preferably, the molarity of the first redox active compound in the electrolyte composition is higher than the molarity of the second redox active compound in the electrolyte composition, e.g. by a factor of at least 1.5. In some embodiments, the factor is between 1.5 and 5, preferably between 1.6 and 4.75, more preferably between 1.7 and 4.5, and even more preferably between 1.8 and 4.

In some embodiments, the concentration of the second redox active compound in the electrolyte composition of the invention is at least 10%, preferably at least 15%, more preferably at least 20%, of the concentration of the first redox active compound, for example at least 10%, 11%, 12%, 13%, 14%, 15%, 16%, 17%, 18%, 19% or 20%.

In some embodiments, the pH of the electrolyte composition of the invention may be between pH 0 and 14. In other embodiments, the pH of the electrolyte composition of the invention may exceed pH 14. Preferably, the pH value of the electrolyte composition is at least 6, e.g. at least 6.5; more preferably at least 7, e.g. at least 7.5; even more preferably at least 8, e.g. at least 8.5; still more preferably at least 9, e.g. at least 9.5; particularly preferably at least 10, e.g. at least 10.5; most preferably at least 11, e.g. at least 12 or 13. In some embodiments, the pH of the electrolyte composition is between 12.5 and 15, preferably between 13 and 14.5.

The pH of the electrolyte composition may be maintained by a buffer. Typical buffers include salts of phosphate, borate, carbonate, silicate, trisaminomethane (Tris), 4-(2-hydroxyethyl)-1-piperazineethanesulfonic acid (HEPES), piperazine-N,N′-bis(ethanesulfonic acid) (PIPES), and combinations thereof. A user may add an acid (e.g., HCl, HNO₃, H₂SO₄ and the like), a base (NaOH, KOH, and the like), or both (e.g. NaOH/KOH, for example as 1:1 mixture) to adjust the pH of a given electrolyte composition as desired.

Accordingly, the electrolyte composition of the invention may optionally comprise further additives, including acids, bases, buffers, ionic liquids, stabilizers, and the like.

In any or all of the embodiments described herein, the electrolyte composition of the invention may further comprise an acid or a base. Preferably, the second electrolyte composition comprises a base. In some embodiments, the electrolyte composition consists essentially of a base, the first redox active component, the second redox active component, and water. Suitable bases include water-soluble metal hydroxides (e.g., alkali metal hydroxides), ammonium hydroxide, or mixtures thereof. Preferably, the base is an alkali metal base. More preferably, the base is a K or Na base, such as KOH or NaOH. Even more preferably, the relation of Na*/K* is 50 mol %/50 mol %. In some embodiments, the base concentration in the electrolyte is within a range of 0.05 M to 5 M, preferably within a range of 0.1 M to 5 M, more preferably within a range of 0.5 M to 4 M, even more preferably within a range of 0.5 M to 3 M, still more preferably within a range of 0.5 M to 2 M.

For example, the electrolyte composition of the inventive may comprise co-solvents; buffering agents; emulsifying agents; further redox active compounds; supporting electrolytes; ionic liquids; acids; bases; viscosity modifiers; wetting agents; stabilizers; salts; or combinations thereof.

Buffers may be selected from citrates, phosphates, borates, carbonates, silicates, carboxylates, sulfonates, alkoxides, trisaminomethane (Tris), 4-(2-hydroxyethyl)-1-piperazineethanesulfonic acid (HEPES), piperazine-N,N′-bis(ethanesulfonic acid) (PIPES), ammonium salts, pyridinium salts, and combinations thereof. Acids may be selected from HCl, H₂SO₄, HClO₄, H₃PO₄, or HNO₃, or a mixture thereof. Bases may be selected from LiOH, NaOH, KOH, LiCl, NaCl, KCl, or a mixture thereof.

Salts may be selected from those comprising monovalent cations (e.g., H⁺, Na⁺, K⁺, NH₄⁺, Cu⁺) or multivalent cations (e.g., Mg²⁺, Ca²⁺, Cu²⁺, Zn²⁺) or both, or those derived from alkali metals, alkaline metals or transition metals, and any suitable anion (e.g., hydroxide, sulfate, nitrate, phosphate, carbonate, perchlorate, or borate) or any combination or mixture thereof. Any combination of the aforementioned additives is also envisaged herein for preparing the first and second redox active composition of the inventive combination.

### Use of the Electrolyte Composition and Redox Flow Battery (RFB)

The present invention also provides the use of the electrolyte composition according to present invention as a (redox flow) battery electrolyte. Preferably the electrolyte composition of the present invention is used as a negolyte. The term “negolyte”, as used herein, refers to the electrolyte, which is in contact with the negative electrode of the (redox flow) battery. Accordingly, the electrolyte, which is in contact with the positive electrode, may also be referred to as the “posolyte”.

In a further aspect, the present invention provides a redox flow battery half-cell comprising the electrolyte composition according to the present invention. The present invention also provides a redox flow battery comprising the electrolyte composition according to the present invention.

Redox flow batteries typically comprise two essentially parallel electrodes separated by a suitable separator, such as an ion exchange membrane, thereby forming two half-cells. Preferably, a redox flow battery according to the invention thus comprises (1) a first half-cell comprising a first electrolyte composition, wherein the first electrolyte composition is according to the present invention as described herein; and (2) a second half-cell comprising a second electrolyte composition, wherein the second electrolyte composition is preferably distinct from the first electrolyte composition. In some embodiments, the second electrolyte composition may not be according to the present invention as described herein. The present invention also provides a redox flow battery comprising: a first electrolyte composition, wherein the first electrolyte composition is according to the present invention; a first electrode in contact with the first electrolyte composition; a second electrolyte composition, wherein the second electrolyte composition is distinct from the first electrolyte composition (other than the electrolyte composition of the present invention); a second electrode in contact with the second electrolyte composition; and a separator interposed between the first and the second electrode and separating the first electrolyte composition from the second electrolyte composition. Preferably, redox flow batteries according to the invention thus comprise (1) a first half-cell comprising a first (e.g., negative) electrode contacting a first (optionally aqueous) electrolyte composition, which is according to the present invention; (2) a second half-cell comprising a second (e.g., positive) electrode contacting a second (optionally aqueous) electrolyte composition (which is preferably distinct from the first electrolyte composition); and (3) a separator (or “barrier”) disposed between the first and second electrolyte compositions.

The redox flow battery cell typically comprises of a first redox flow battery half-cell harbouring the negative electrode in contact with the first electrolyte composition (which is the electrolyte composition of the invention) and—separated therefrom by a suitable separator or barrier—a second half-cell harbouring a positive electrode in contact with the second electrolyte composition. Preferably, the half-cells are configured as separate reservoirs (or chambers) within the redox flow battery cell, through which the first and/or second electrolyte compositions flow so as to contact the respective electrodes disposed in the electrolyte composition, and the separator.

The negative electrode reservoir (also referred to as “negolyte chamber”) comprises the negative electrode immersed within the negative electrode electrolyte composition in a container and forms a first redox flow battery half-cell. The positive electrode chamber (“posolyte chamber”) comprises the positive electrode immersed within the positive electrode electrolyte composition in a container and forms the second redox flow battery half-cell. Each container and its associated electrode and electrolyte composition thus defines its corresponding redox flow battery half-cell. The containers of each redox flow battery half-cell may be composed of any preferably chemically inert material suitable to retain the respective electrolyte compositions. Each electrolyte composition preferably flows through its corresponding redox flow battery half-cell flow so as to contact the respective electrode disposed within the electrolyte, and the separator. The electrochemical redox reactions of the employed redox active compounds occur within the redox flow battery half-cells.

Specifically, the present invention thus provides a redox flow battery comprising: a first (optionally aqueous) electrolyte composition (electrolyte composition of the invention); a first electrode in contact with said first (optionally aqueous) electrolyte composition; a second (optionally aqueous) electrolyte composition (preferably distinct from the first electrolyte composition); a second electrode in contact with said second (optionally aqueous) electrolyte composition.

The posolyte and negolyte chamber defining the corresponding redox flow battery half-cells are preferably connected to a power source. Further, each chamber may be connected, preferably via suitable ducts, to at least one separate storage tank comprising the respective electrolyte composition flowing through said chamber. The storage tank volume determines the quantity of energy stored in the system, which may be measured in kWh. The ducts may comprise transportation means (e.g. pumps, openings, valves, ducts, tubing) for transporting the electrolyte compositions from the storage tanks through the corresponding half-cell chamber.

The redox flow battery cell may further comprise control software, hardware, and optional safety systems such as sensors, mitigation equipment, meters, alarms, wires, circuits, switches, signal filters, computers, microprocessors, control software, power supplies, load banks, data recording equipment, power conversion equipment, and other devices and other electronic/hardware controls and safeguards to ensure safe, autonomous, and efficient operation of the redox flow battery. Such systems are known to those of ordinary skill in the art.

Typically, the first redox flow battery half-cell is separated from the second redox flow battery half-cell by a separator (also referred to as a “membrane” or “barrier” herein). Said separator preferably functions to (1) (substantially) prevent mixing of first and second electrolyte, i.e. physically separates the posolyte and negolyte from each other; (2) reduces or prevents short circuits between the positive and negative electrodes; and (3) enables ion (typically H⁺) transport between the positive and negative electrolyte chambers, thereby balancing electron transport during charge and discharge cycles. The electrons are primarily transported to and from an electrolyte through the electrode contacting that electrolyte.

Suitable separator materials may be chosen by the skilled artisan from separator materials known in the art as long as they are (electro-)chemically inert and do not, for example, dissolve in the solvent or electrolyte. Separators are preferably cation-permeable, i.e. allow the passage of cations such as H⁺ (or alkali ions, such as sodium or potassium), but is at least partially impermeable to the redox active compounds. The separator may for instance be selected from an ion conducting membrane or a size exclusion membrane. Separators are generally categorized as either solid or porous. Solid separators may comprise an ion-exchange membrane, wherein an ionomer facilitates mobile ion transport through the body of the polymer which constitutes the membrane. The facility with which ions conduct through the membrane can be characterized by a resistance, typically an area resistance in units of ohm-cm². The area resistance is a function of inherent membrane conductivity and the membrane thickness. Thin membranes are desirable to reduce inefficiencies incurred by ion conduction and therefore can serve to increase voltage efficiency of the redox flow battery cell. Active material crossover rates are also a function of membrane thickness, and typically decrease with increasing membrane thickness. Crossover represents a current efficiency loss that must be balanced with the voltage efficiency gains by utilizing a thin membrane.

Such ion-exchange membranes may also comprise or consist of membranes, which are sometimes referred to as polymer electrolyte membranes (PEMs) or ion conductive membranes (ICMs). The membranes may comprise any suitable polymer, typically an ion exchange resin, for example comprising a polymeric anion or cation exchange membrane, or combination thereof. The mobile phase of such a membrane may comprise, and/or is responsible for the primary or preferential transport (during operation of the battery) of at least one mono-, di-, tri-, or higher valent cation and/or mono-, di-, tri-, or higher valent anion, other than protons or hydroxide ions.

Substantially non-fluorinated membranes that are modified with sulfonic acid groups (or cation exchanged sulfonate groups) may also be used. Such membranes include those with substantially aromatic backbones, e.g., poly-styrene, polyphenylene, bi-phenyl sulfone (BPSH), or thermoplastics such as polyetherketones or polyethersulfones. Examples of ion-exchange membranes comprise NAFION®.

Porous separators may be non-conductive membranes that allow charge transfer between two electrodes via open channels filled with conductive electrolyte composition. Porous membranes are typically permeable to liquid or gaseous chemicals. This permeability increases the probability of chemicals (e.g. electrolytes) passing through porous membrane from one electrode to another causing cross-contamination and/or reduction in cell energy efficiency. The degree of this cross-contamination depends on, among other features, the size (the effective diameter and channel length), and character (hydrophobicity/hydrophilicity) of the pores, the nature of the electrolyte, and the degree of wetting between the pores and the electrolyte composition. Because they contain no inherent ionic conduction capability, such membranes are typically impregnated with additives in order to function. These membranes are typically comprised of a mixture of a polymer, and inorganic filler, and open porosity. Suitable polymers include those chemically compatible with the electrolytes and electrolyte compositions described herein, including high density polyethylene, polypropylene, polyvinylidene difluoride (PVDF), or polytetrafluoroethylene (PTFE). Suitable inorganic fillers include silicon carbide matrix material, titanium dioxide, silicon dioxide, zinc phosphide, and ceria and the structures may be supported internally with a substantially non-ionomeric structure, including mesh structures such as are known for this purpose in the art.

Separators may feature a thickness of about 500 microns or less, about 300 microns or less, about 250 microns or less, about 200 microns or less, about 100 microns or less, about 75 microns or less, about 50 microns or less, about 30 microns or less, about 25 microns or less, about 20 microns or less, about 15 microns or less, or about 10 microns or less, for example to about 5 microns.

The negative and positive electrodes of the inventive redox flow battery provide a surface for electrochemical reactions during charge and discharge. As used herein, the terms “negative electrode” and “positive electrode” are electrodes defined with respect to one another, such that the negative electrode operates or is designed or intended to operate at a potential more negative than the positive electrode (and vice versa), independent of the actual potentials at which they operate, in both charging and discharging cycles. The negative electrode may or may not actually operate or be designed or intended to operate at a negative potential relative to the reversible hydrogen electrode.

The negative electrode may be associated with the first electrolyte composition as described herein and the positive electrode may be associated with the second electrolyte composition.

Accordingly, the first electrolyte composition is preferably a negolyte and the second electrolyte composition is preferably a posolyte.

The inventive redox flow battery typically comprises a first (negative) and second (positive) electrode (anode and cathode, respectively).

The negative and positive electrodes of the inventive redox flow battery provide a surface for electrochemical reactions during charge and discharge. The first and second electrode may comprise or consist of the same or a different material(s).

Suitable electrode materials may be selected from any electrically conductive material that is chemically and electrochemically stable (i.e., inert) under the desired operating conditions.

Electrodes may comprise more than one material as long as their surface is preferably covered by an electrically conductive and (electro)chemically inert material.

Exemplary electrode materials for use in the inventive redoxflow battery may be selected, without limitation, from a metal, such as titanium, platinum, copper, aluminium, nickel or stainless steel.

Preferably, the material of one or both electrodes is a carbon material, such as glassy carbon, carbon black, activated carbon, amorphous carbon, graphite, graphene, carbon mesh, carbon paper, carbon felt, carbon foam, carbon cloth, carbon paper, or carbon nanotubes; and an electroconductive polymer; or a combination thereof. The term “carbon material” refers to materials which are primarily composed of the element carbon, and typically further contain other elements, such as hydrogen, sulfur, oxygen, and nitrogen. Carbon materials containing a high surface area carbon may be preferred due to their capability of improving the efficiency of charge transfer at the electrode. Accordingly, the redox flow battery comprises preferably at least one carbon-based electrode, preferably a carbon-based cathode and/or a carbon-based anode. Preferably, a carbon-based electrode is a pressed carbon electrode. In some embodiments, the electrode may comprise graphite and polypropylene (PP), for example at least 70%, preferably at least 75%, more preferably at least 80% graphite. In a specific example, the electrode (or both electrodes) is/are pressed carbon electrode(s) with 80% graphite-20% PP electrodes with carbon black surface.

The electrodes may take the form of a plate, which may preferably exhibit an increased surface area, such as a perforation plate, a wave plate, a mesh, a surface-roughened plate, a sintered porous body, and the like. In some embodiments, the electrode(s) may have a regularly rhombus shaped surface pattern, e.g. with maximal height of structures of 1.4 mm. The size of the electrode(s) may be, for example, about 41 mm×about 41 mm×about 0.72 mm. Electrodes also may be formed by applying any suitable electrode material onto the separator.

Preferably, the electrolyte compositions within the inventive redox flow battery are provided in liquid form, either in pure liquid form or dissolved in a suitable solvent, e.g. water, methanol, ethanol, dimethylsulfoxide, acetonitrile, acetone, glycol or mixtures thereof, i.e. as electrolyte compositions as described in greater detail elsewhere herein. Preferably, the first and/or the second electrolyte composition(s) is/are aqueous compositions.

The pH of the first and second electrolyte compositions may be equal or substantially similar; or the pH of the two electrolytes differ by a value in the range of about 0.1 to about 2 pH units, about 1 to about 10 pH units, about 5 to about 12 pH units, about 1 to about 5 pH units, about 0.1 to about 1.5 pH units, about 0.1 to about 1 pH units, or about 0.1 to about 0.5 pH units. In this context, the term “substantially similar,” without further qualification, is intended to connote that the difference in pH between the two electrolytes is about 1 pH unit or less, such as about 0.4 or less, about 0.3 or less, about 0.2 or less, or about 0.1 pH units or less.

In some embodiments, the redox flow battery according to the invention may comprise (1) a first half-cell comprising a first electrolyte composition (according to the invention), in contact with the first, e.g. negative, electrode and (2) a second half-cell comprising a second electrolyte composition (preferably distinct from the first electrolyte composition, e.g. not according to the invention), in contact with the second, e.g. positive, electrode, or vice versa.

Optionally, the redox flow battery according to the invention may comprise, as a redox active compound in the second electrolyte composition, an inorganic compound. Examples of inorganic redox active compounds of the second electrolyte composition include, but are not limited to, chlorine, bromine, iodine, oxygen, vanadium, chromium, cobalt, iron, manganese, cobalt, nickel, copper, and lead compounds. In particular, the inorganic redox active compound of the second electrolyte composition may be a metal ion salt, preferably an iron ion salt (Fe ion salt). In some embodiments, the inorganic redox active compound of the second electrolyte composition may be selected from bromine or a manganese oxide, a cobalt oxide and a lead oxide. In some embodiments, the inorganic redox active compound of the second electrolyte composition may be a metal (e.g. Fe) complexes, e.g. an iron based ligand complexes. Preferably, the second electrolyte composition comprises (as redox active compound) a salt of Fe (“Fe-salt”), more preferably a salt of Fe(CN)₆³⁻ and/or a salt of Fe(CN)₆⁴⁻. For example, the second electrolyte composition may comprise (as redox active compound) one or more salt(s) of Fe(CN)₆³⁻ and/or one or more salt(s) of Fe(CN)₆⁴⁻, or combinations thereof. Preferably, the salt of Fe(CN)₆³⁻ and/or the salt of Fe(CN)₆⁴⁻ is an alkali salt, more preferably a Na⁺ and/or K⁺ salt. A particularly preferred example of the redox active compound of the second electrolyte composition is K₄[Fe(CN)₆] or Na₂K₂Fe(CN)₆.

In some embodiments, the second electrolyte composition may not comprise a redox active compound of General Formula (I). In particular, the second electrolyte composition may not comprise a phenazine (derivative) (as redox active compound). In some embodiments, the second electrolyte composition comprises only the metal ion salt, e.g. alkali salt of Fe(CN)₆³⁻ and/or the salt of Fe(CN)₆⁴⁻ is an alkali salt, such as K₄[Fe(CN)₆], as redox active compound. In other words, in some instances, the second electrolyte composition may comprise no further redox active compound, other than the metal ion salt, e.g. alkali salt of Fe(CN)₆³⁻ and/or the salt of Fe(CN)₆⁴⁻ is an alkali salt, such as K₄[Fe(CN)₆].

The concentration of the Fe-salt in the second electrolyte composition may be below 5 M, preferably below 4 M, more preferably below 3 M, even more preferably below 2 M, and still more preferably below 1.0 M, for example below 0.9 or 0.8 M. As a specific example, no more than 0.7 M (e.g., 0.68 M) Na₂K₂Fe(CN)₆ may be used in the second electrolyte composition (posolyte; e.g., in 0.25 M Na/KOH, Na⁺/K⁺=1:1).

In some embodiments, the second electrolyte composition further comprises a base or an acid. Preferably, the second electrolyte composition comprises a base. In some embodiments, the electrolyte composition consists essentially of a base, the first redox active component, the second redox active component, and water. Suitable bases include water-soluble metal hydroxides (e.g., alkali metal hydroxides), ammonium hydroxide, or mixtures thereof. Preferably, the base is an alkali metal base. More preferably, the base is a K or Na base, such as KOH or NaOH. Even more preferably, the relation of Na⁺/K⁺ is 1:1. In some embodiments, the base concentration in the electrolyte is within a range of 0.05 M to 5 M, preferably within a range of 0.1 M to 4 M, more preferably within a range of 0.15 M to 3 M, even more preferably within a range of 0.2 M to 2 M.

Flow patterns of a redox flow battery can be categorized into two types: “flow-through” type without flow field and “flow-by” type which has a flow field design, e.g. on a bipolar plate. In the “flow-through” type, the electrolyte composition flows through the (porous carbon felt) electrode. In the “flow-by” type, the electrolyte composition flows by the surface of an electrode, e.g. following the flow field at a bipolar plate. Preferably, the redox flow battery is of the “flow-by” type. Accordingly, it is preferred that the electrode is a flow-by electrode. In particular the anode may be a flow-by electrode and/or the cathode may be a flow-by electrode. More preferably, the redox flow battery is of the “flow-by” type and the electrode(s) is/are carbon-based electrode(s) as described above.

The disclosed redox flow battery may also be characterized in terms of its half-cell reduction potentials. Both the negative and positive electrode preferably exhibit a half-cell standard reduction potential. A redox flow battery cell according to the present disclosure may exhibit a half-cell potential for the negative electrode less than about +0.3 V vs. SHE (standard hydrogen electrode), preferably less than about +0.1V vs. SHE. Preferably, a redox flow battery cell according to the present invention may exhibit a half-cell potential for the positive electrode (e.g., the second half-cell) of at least about >0 V vs. SHE, preferably at least +0.1 V vs. SHE, more preferably at least about 0.2 V vs. SHE.

The disclosed redox flow batteries may also be characterized in terms of their energy density. Flow batteries of the present disclosure may operate, for example, with an energy density of, at least between about 10 Wh/L per side and about 20 Wh/L per side, preferably between about 20 Wh/L per side and about 50 Wh/L per side, more preferably between about 50 Wh/L per side and about 100 Wh/L per side.

In a charging cycle, electrical power is applied to the system. Thereby, the redox active compound contained in the one (for instance the first) electrolyte composition undergoes one-or-more electron oxidation and the redox active compound in the other (for instance the second) electrolyte composition undergoes one-or-more electron reduction. Similarly, in a discharge cycle one (for instance the first) redox active compound is reduced and the other (for instance the second) redox active compound is oxidized producing electrical power.

In some cases, a user may desire to provide higher charge or discharge voltages than available from a single battery. In such cases, and in certain embodiments, several batteries may be connected in series such that the voltage of each cell is additive. An electrically conductive, but non-porous material (e.g., a bipolar plate) may be employed to connect adjacent battery cells in a bipolar stack, which allows for electron transport but prevents fluid or gas transport between adjacent cells. The positive electrode compartments and negative electrode compartments of individual cells are suitably fluidically connected via common positive and negative fluid manifolds in the stack. In this way, individual electrochemical cells can be stacked in series to yield a desired operational voltage.

Several redox flow batteries may be connected in series via electrically conductive, preferably non-porous material which allows for electron transport but prevents fluid or gas transport between adjacent cells (e.g., a bipolar plate) in a bipolar redox flow battery stack. Positive and negative electrode compartments of each cell are preferably connected via common positive and negative fluid manifolds in the stack. Thereby, individual electrochemical cells can be stacked in series to yield a desired operational voltage.

The term “bipolar plate” refers to an electrically conductive, substantially nonporous material that may serve to separate electrochemical cells in a cell stack such that the cells are connected in series and the cell voltage is additive across the cell stack. The bipolar plate has two surfaces such that one surface of the bipolar plate serves as a substrate for the positive electrode in one cell and the negative electrode in an adjacent cell. The bipolar plate typically comprises carbon and carbon containing composite materials.

Redox flow battery cells, cell stacks, or redox flow batteries as described herein comprising the electrolyte composition of the present invention may be incorporated in larger energy storage systems, suitably including piping and controls useful for operation of these large units. Piping, control, and other equipment suitable for such systems are known in the art, and include, for example, piping and pumps in fluid communication with the respective electrochemical reaction chambers for moving electrolyte compositions into and out of the respective chambers and storage tanks for holding charged and discharged electrolyte compositions.

The storage tanks contain the redox active materials; the tank volume determines the quantity of energy stored in the system, which may be measured in kWh. The control software, hardware, and optional safety systems suitably include sensors, mitigation equipment and other electronic/hardware controls and safeguards to ensure safe, autonomous, and efficient operation of the flow battery energy storage system. Such systems are known to those of ordinary skill in the art. A power conditioning unit may be used at the front end of the energy storage system to convert incoming and outgoing power to a voltage and current that is optimal for the energy storage system or the application. For the example of an energy storage system connected to an electrical grid, in a charging cycle the power conditioning unit would convert incoming AC electricity into DC electricity at an appropriate voltage and current for the electrochemical stack. In a discharging cycle, the stack produces DC electrical power and the power conditioning unit converts to AC electrical power at the appropriate voltage and frequency for grid applications.

The energy storage and generation systems described herein may also include electrolyte circulation loops, which may comprise one or more valves, one or more pumps, and optionally a pressure equalizing line. Hence, the energy storage system according to the invention may comprise at least one redox flow battery, a first chamber containing the first (preferably aqueous) electrolyte and a second chamber containing the second (preferably aqueous) electrolyte; at least one electrolyte circulation loop in fluidic communication each electrolyte chamber, said at least one electrolyte circulation loop comprising storage tanks and piping for containing and transporting the electrolytes; control hardware and software (which may include safety systems); and an optional power conditioning unit.

The energy storage and generation systems of this disclosure can also include an operation management system. The operation management system may be any suitable controller device, such as a computer or microprocessor, and may contain logic circuitry that sets operation of any of the various valves, pumps, circulation loops, and the like.

### BRIEF DESCRIPTION OF THE FIGURES

In the following a brief description of the appended figures will be given. The figures are intended to illustrate the present invention in more detail. However, they are not intended to limit the subject matter of the invention in any way.

FIG. 1 shows cell polarization and performance with cells with an electrolyte composition of the invention (“DHPS+AQ”) and a comparative electrolyte composition (“DHPS”).

FIG. 2 shows a charge and discharge curve for a cell with an electrolyte composition of the invention (“DHPS+AQ”) and a comparative electrolyte composition (“DHPS”).

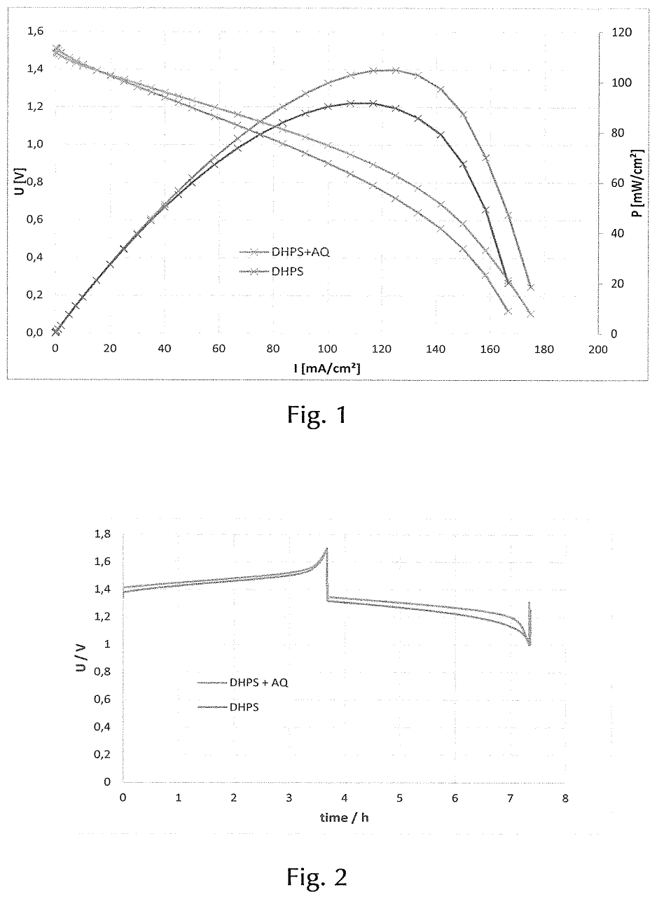

### EXAMPLES

In the following, particular examples illustrating various embodiments and aspects of the invention are presented. However, the present invention shall not to be limited in scope by the specific embodiments described herein. The following preparations and examples are given to enable those skilled in the art to more clearly understand and to practice the present invention. The present invention, however, is not limited in scope by the exemplified embodiments, which are intended as illustrations of single aspects of the invention only, and methods which are functionally equivalent are within the scope of the invention. Indeed, various modifications of the invention in addition to those described herein will become readily apparent to those skilled in the art from the foregoing description, accompanying figures and the examples below. All such modifications fall within the scope of the appended claims.

### Example 1

### Flow-by Cells (FB Cell):

For electrochemical characterization, a small laboratory cell is used. A cell assembly with pressed carbon electrodes (80% graphite-20% PP electrodes with carbon black surface, 41 mm×41 mm×0.72 mm, regularly rhombus shaped surface pattern with maximal height of structures of 1.4 mm) as both the positive and negative electrode is employed. The gap between the base electrode surface and membrane is 1.5 mm on each side of the cell. A cation exchange membrane (620PE, supplier: fumatech) is used to separate the positive and negative electrolytes. The membrane is conditioned in 0.5 M KOH/NaOH (KOH/NaOH=1:1) for at least 150 h prior to each test. 25 mL of negolyte electrolyte composition (sum of active material is 0.5 M) and 54 mL of Na₂K₂Fe(CN)₆ as posolyte (0.68 M, in 0.25 M Na/KOH, Na⁺/K⁺=1:1) is used. Two distinct negolyte electrolyte compositions were tested, namely an electrolyte composition according to the invention (“DHPS+AQ”) and a comparative electrolyte composition (“DHPS”):
“DHPS+AQ”: 0.4 M 7,8-dihydroxyphenazine-2-sulfonic acid, 0.1 M 2,6-dihydroxyanthraquinone, 0.95 M NaOH, 0.95 KOH
“DHPS”: 0.5 M 7,8-dihydroxyphenazine-2-sulfonic acid, 1.0 M NaOH, 1.0 KOH

According to Faraday's law, a maximum capacity of 26.8 Ah/L is achievable. Electrolytes are pumped by peristaltic pumps (Drifton BT100-1L, Cole Parmer Ismatec MCP and BVP Process IP 65) at a rate of 72 mL/min to the corresponding electrodes, respectively. The electrolyte reservoirs are purged with N₂ gas for 1 h before start of charging and the inert atmosphere is maintained during the experiments.

Electrochemical testing is performed on a BaSyTec (BaSyTec GmbH, 89176 Asselfingen, Germany) or a Bio-Logic (Bio-Logic Science Instruments, Seyssinet-Pariset 38170, France) battery test system. In the beginning, polarization curves are obtained by galvanostatic discharging holds after potentiostatic charging to 1.6V (1.5 mA/cm² current limitation). The cell is afterwards cycled potentiostatically (1.6-1.0V, 1.5 mA/cm²) for 5 cycles, followed by galvanostatic cycling with a current density of 20 mA/cm² (1.7-1.0V).

The results are summarized in Table 1 below:

TABLE 1
Electrochemical performance data for the distinct
electrolyte compositions used as negolyte.

| | DHPS | DHPS + AQ |
|---|---|---|
| Cell resistance [Ωcm²] | 5.8 | 4.6 |
| Maximum performance [mW/cm²] | 92 | 105 |
| RTE [%] | 80% | 83% |
| Average discharging voltage [V] | 1.24 | 1.29 |
| Average charging voltage [V] | 1.48 | 1.49 |

These data show that the electrolyte composition of the present invention is superior to a comparative electrolyte composition comprising only a phenazine (derivative) as redox active compound.

### Example 2

Next, further electrolyte compositions according to the present invention were tested with (i) DHPS (as first redox active compound) and (ii) different non-phenazine second redox active compounds as described in the following.

### Flow-Through Cells (FT Cell):

For electrochemical characterization, a small laboratory cell is used. A graphite felt (with an area of 6 cm², 6 mm in thickness, supplier: SGL Sigracell GFA 6EA) in combination with a bipolar plate (4.1 cm×4.1 cm, SGL Sigracell TF6) is employed as both the positive and negative electrode. A cation exchange membrane (630K or 620PE, supplier: fumatech) is used to separate the positive and negative electrolytes. The membrane is conditioned in an aqueous solution of 0.5 M base (KOH/NaOH=1:1) for at least 150 h prior to each test. As anolyte and catholyte, the aqueous solutions according to table 2 are used. The pH-values were adjusted using a 1:1 mixture of NaOH/KOH. The catholyte is always employed in stoichiometric excess in order to obtain charge limitation solely out of the anolyte (see table 2) Both electrolytes are pumped by peristaltic pumps (Drifton BT100-1L, Cole Parmer Ismatec MCP and BVP Process IP 65) at a rate of 24 mL/min to the corresponding electrodes, respectively. The electrolyte reservoirs are purged with N₂ gas for 1 h before start of charging and the inert atmosphere is maintained during the course of the experiments.

TABLE 2
Compositions of employed anolyte and catholyte
aqueous solutions in Example 2.

| | Anolyte composition | Catholyte composition |
|---|---|---|
| DHPS + | 0.10M DHPS | 0.29M Na₂K₂[Fe(CN)₆] |
| Lawsone | 0.03M Lawsone | |
| DHPS + | 0.11M DHPS | 0.53M Na₂K₂[Fe(CN)₆] |
| Alizarin Red S | 0.04M Alizarin Red S | |
| DHPS + | 0.11M DHPS | 0.30M Na₂K₂[Fe(CN)₆] |
| Alizarin | 0.04M Alizarin | |
| DHPS + | 0.09M DHPS | 0.29M Na₂K₂[Fe(CN)₆] |
| Bislawsone | 0.05M Bislawsone | |

### Electrochemical Tests:

Electrochemical testing is performed on a BaSyTec (BaSyTec GmbH, 89176 Asselfingen, Germany) or a Bio-Logic (Bio-Logic Science Instruments, Seyssinet-Pariset 38170, France) battery test system. For galvanostatic cycling, the cell is charged at a current density of 25 mA/cm² (FT) or 20 mA/cm² (FB) up to 1.7 V and discharged at the same current density down to 1.0 or 0.8 V cut-off. A full potentiostatic cycle with voltage limitations of 1.6 V for charging and 1.0 or 0.8 V for discharging with <1.5 mA/cm² current limitation is conducted in order to get maximum electrolyte exploitation and to calculate the accessible maximum charge per volume of used Phenazine electrolyte.

According to Faraday's law, a maximum capacity of 26.8 Ah/L is achievable. Electrolytes are pumped by peristaltic pumps (Drifton BT100-1L, Cole Parmer Ismatec MCP and BVP Process IP 65) at a rate of 72 mL/min to the corresponding electrodes, respectively. The electrolyte reservoirs are purged with N₂ gas for 1 h before start of charging and the inert atmosphere is maintained during the experiments.

The results are summarized in table 3:

TABLE 3
Electrochemical performance data for the distinct compositions, assigned to the
respective anolyte solutions (RTE = round-trip efficiency, n.d. = not determined).

| | DHPS | DHPS + | DHPS + | DHPS + | DHPS + | DHPS + |
|---|---|---|---|---|---|---|
| | (Ex. 1) | AQ (Ex. 1) | Lawsone | Alizarin Red S | Alizarin | Bislawsone |
| Cell resistance | 5.8 | 4.6 | 3.5 | n.d. | n.d. | 3.4 |
| [ [symbol] cm²] | | | | | | |
| Maximum | 92 | 105 | 143 | n.d. | n.d. | 120 |
| performance | | | | | | |
| [mW/cm²] | | | | | | |
| RTE [%] | 80 | 83 | 84 | 81 | 83 | 83 |
| Average discharging | 1.24 | 1.29 | 1.16 | 1.16 | 1.17 | 1.21 |
| voltage [V] | | | | | | |
| Average charging | 1.48 | 1.49 | 1.36 | 1.40 | 1.39 | 1.02 |
| voltage [V] | | | | | | |

These data confirm that the electrolyte compositions of the present invention are superior to a comparative electrolyte composition comprising only one phenazine (derivative) as redox active compound by combining the first redox active compound with further exemplary non-phenazine second redox-active compounds.

1. An electrolyte composition comprising
(i) a first redox active compound, which is characterized by General Formula (I), or a salt thereof: 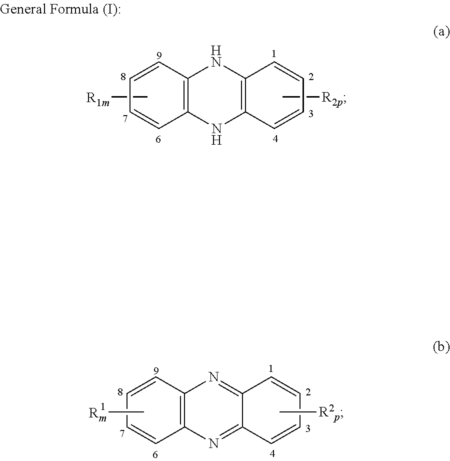
wherein:
R¹ and R² are selected independently from each other from the group consisting of Rₐ—R_{d}, Rₐ—R_{b}—R_{c}, Rₐ—Rₐ—R_{c}, R_{b}—R_{c}, R_{b}—Rₐ—R_{b}—R_{c}, R_{b}—Rₐ—Rₐ—R_{c}, R_{b}—Rₑ(R_{b}—R_{c})₂, R_{b}—Rₑ(Rₐ—R_{c})₂, R_{b}—N(R_{b}—R_{c})₃X, R_{c}, R_{d}, Rₐ—R_{c}, Rₐ—Rₐ—R_{b}—R_{c}, Rₐ—Rₐ—Rₐ—R_{c}, Rₐ—Rₑ(R_{b}—R_{c})₂, Rₐ—Rₑ(Rₐ—R_{c})₂, Rₐ—N(Rₐ—R_{c})₃X, Rₐ—N(R_{b}—R_{c})₃X, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(Rₐ—R_{c})₃X,
wherein
Rₐ is selected from the group consisting of —SO₃—, —SO₂(NH)—, —(NH)SO₂—, —SO₂(NR_{d})—, —(NR_{d})SO₂—, —OSO₃—, —OSO₂(NH)—, —(NH)SO₂O—, —OSO₂NR_{d}—, —(NR_{d})SO₂O—, —PO₃H—, —PO₂H(NH)—, —PO₂HNR_{d}—, —OPO₃H—, —OPO₂H(NH)—, —OPO₂HNR_{d}—, —C(═O)O—, —CO(NH)—, —(NH)CO—, —CONR_{d}—, —(NR_{d})CO—, —O—, —NH—, -heteroaryl, and -heterocyclyl,
R_{b} is selected from the group consisting of —CH₂C(OH)HR_{d}—, —R_{d}—O—R_{d}—, —R_{d}—(OC₂H₄)ₙ—, and R_{d}—(OCH₂C(CH₃)H)ₙ—, wherein n is an integer selected from 1 to 50,
R_{c} is selected from the group consisting of —H, —OH, —OR_{d}, —OC(═O)R_{d}, —NH₂, —NH(R_{d}), —N(R_{d})₂, —N(R_{d})₃X, —C(═O)NH₂, —C(═O)(NH)R_{d}, —C(═O)OH, —C(═O)R_{b}—H, —SO₃H, —SO₃R_{d}, —SO₂NH₂, —SO₂(NH)R_{d}, —OSO₃H, —OSO₃R_{d}, —OSO₂NH₂, —OSO₂(NH)R_{d}, —PO₃H₂, —PO₃HR_{d}, —PO₃(R_{d})₂, —OPO₃H₂, —OPO₃HR_{d}, —OPO₃(R_{d})₂, -halogen, -aryl, —CHO, —CN, -heteroaryl, and -heterocyclyl,
R_{d} is a linear or branched, saturated or unsaturated C₁-C₉ chain,
Rₑ is selected from the group consisting of —PO₃—, —OPO₂—, and —N—, and
X is selected from the group consisting of —Cl, —Br, —I, and ½ —SO₄; and
wherein
m and p are selected independently from each other from any integer of 0, 1, 2, 3, and 4;
(ii) a second redox active compound, which is not characterized by General Formula (I); and
(iii) a solvent.

2.-10. (canceled)

11. The electrolyte composition according to claim 1, wherein
R¹ and R² are selected independently from each other from the group consisting of Rₐ—R_{b}—R_{c}, Rₐ—R_{d}—R_{c}, R_{b}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), —N(R_{b}—R_{c})₃X, and —N(R_{d}—R_{c})₃X,
wherein
Rₐ is selected from the group consisting of —CO(NH)—, —(NH)CO—, —CONR_{d}—, —(NR_{d})CO—, —O—, —NH—, -heteroaryl, and -heterocyclyl,
R_{b} is selected from the group consisting of —CH₂C(OH)HR_{d}—, —R_{d}—O—R_{d}—, and —R_{d}—(OC₂H₄)ₙ—, wherein n is an integer selected from 1 to 20,
R_{c} is selected from the group consisting of —H, —OH, —OR_{d}, —NH₂, —N(R_{d})₃X, —C(═O)NH₂, —C(═O)OH, —SO₃H, —OSO₃H, —PO₃H₂, -halogen, -aryl, —CN, -heteroaryl, and -heterocyclyl,
R_{d} is a linear or branched, saturated C₁-C₉ chain,
Rₑ is —N—, and
X is selected from the group consisting of —Cl, —Br, and ½ —SO₄; and
wherein
m is an integer selected from 0, 1, 2, and 3; and
p is an integer selected from 0, 1, and 2.

12. The electrolyte composition according to claim 11, wherein
R¹ and R² are selected independently from each other from the group consisting of Rₐ—R_{b}—R_{c}, Rₐ—R_{d}—R_{c}, R_{c}, R_{d}, R_{d}—R_{c}, Rₑ(R_{b}—R_{c})₂, Rₑ(R_{d}—R_{c})₂, Rₑ(R_{d}—R_{c})(R_{b}—R_{c}), and —N(R_{b}—R_{c})₃X,
wherein
Rₐ is —O— or —NH—,
R_{b} is —CH₂C(OH)HR_{d}— or —R_{d}—(OC₂H₄)ₙ—, wherein n is an integer selected from 1 to 5,
R_{c} is selected from the group consisting of —H, —OH, —NH₂, —C(═O)OH, —SO₃H, -aryl, —CN, -heteroaryl, and -heterocyclyl,
R_{d} is a linear or branched, saturated C₁-C₅ chain,
Rₑ is —N—, and
X is —Cl or —SO₄; and
wherein
m is an integer selected from 0, 1, and 2; and
p is 0 or 1.

13. The electrolyte composition according to claim 1, wherein m is 1 or 2 and R¹ is positioned at ring position 7 and/or 8; and/or wherein p is 1 or 2 and R² is positioned at ring position 2 and/or 3.

14.-18. (canceled)

19. The electrolyte composition according to claim 1, wherein the composition comprises at least one compound according to Formula (I)(a) (reduced state) and at least one corresponding compound of Formula (I)(b) (oxidized state).

20. The electrolyte composition according to claim 1, wherein the composition comprises at least two distinct redox active compounds characterized by General Formula (I) as defined in any one of the previous claims.

21. The electrolyte composition according to claim 1, wherein the second redox active compound is not a starting material or intermediate product in the synthesis of the first redox active compound.

22. The electrolyte composition according to claim 1, wherein the electrolyte composition does not comprise 2,5-dihydroxy-1,4-benzoquinone.

23. The electrolyte composition according to claim 1, wherein the second redox active compound is selected from the group consisting of inorganic ions (e.g., metal ions, halogen ions), metal complexes, polysulfide/sulfur systems, and metal-free organic compounds not according to General Formula (I).

24. (canceled)

25. The electrolyte composition according to claim 1, wherein the second redox active compound is a quinone compound.

26. The electrolyte composition according to claim 1, wherein the second redox active compound is characterized by any one of General Formulas (II) to (IV):
General Formula (II): 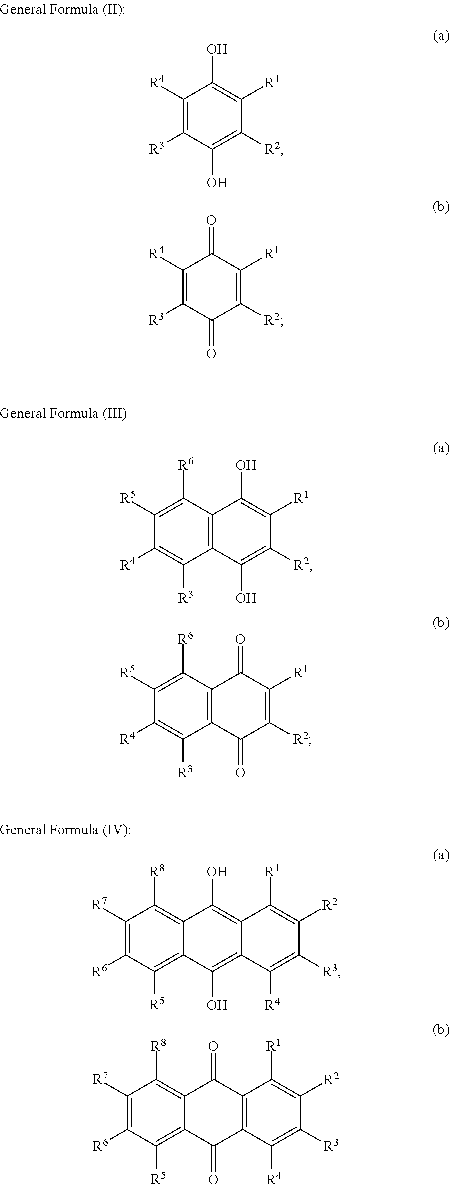
wherein
each of R¹-R⁴ in formula (II); R¹-R⁶ in formula (III); and/or R¹-R⁸ in formula (IV) is independently selected from hydrogen; hydroxyl; carboxy; optionally substituted C₁₋₆ alkyl optionally comprising at least one heteroatom selected from N, O and S, including —CₙH₂ OH, —CₙH₂ₙNH₂ and —CₙH₂ SO₃H, wherein n is an integer selected from 1, 2, 3, 4, 5, or 6; carboxylic acids; esters; halogen; optionally substituted C₁₋₆ alkoxy, including methoxy and ethoxy; optionally substituted amino, including primary, secondary, tertiary and quaternary amines; amide; nitro; carbonyl; phosphoryl; phosphonyl; cyanide; and sulfonyl (—SO₃H);
or an alkali salt thereof.

27.-32. (canceled)

33. The electrolyte composition according to claim 26, wherein the composition comprises at least two distinct redox active compounds characterized by any one of General Formulas (II) to (IV).

34. The electrolyte composition according to claim 1, wherein the composition does not comprise lithium or a compound comprising lithium.

35. The electrolyte composition according to claim 1, wherein the composition is an aqueous composition and optionally comprises an organic solvent, in particular an organic water-miscible solvent.

36.-46. (canceled)

47. A redox flow battery comprising:
a first half-cell comprising a first electrolyte composition, wherein the first electrolyte composition is according to claim 1; and
a second half-cell comprising a second electrolyte composition, wherein the second electrolyte composition is distinct from the first electrolyte composition.

48. (canceled)

49. The redox flow battery according to claim 47 further comprising:
a first electrode in contact with the first electrolyte composition;
a second electrode in contact with the second electrolyte composition; and
a separator interposed between the first and the second electrode and separating the first electrolyte composition from the second electrolyte composition.

50. The redox flow battery according to claim 47, wherein said redox flow battery comprises at least one carbon-based electrode, preferably a carbon-based cathode and/or a carbon-based anode-, wherein the electrode preferably is a flow-by electrode.

51. (canceled)

52. (canceled)

53. The redox flow battery according to claim 47, wherein the first electrolyte composition is a negolyte and the second electrolyte composition is a posolyte.

54. The redox flow battery according to claim 47, wherein the second electrolyte composition comprises at least one inorganic redox active species, preferably a metal ion salt, more preferably an Fe ion salt.

55. The redox flow battery according to claim 54, wherein the second electrolyte composition comprises a salt of Fe(CN)₆³⁻ and/or a salt of Fe(CN)₆⁴⁻,wherein the salt of Fe(CN)₆³⁻ and/or the salt of Fe(CN)₆⁴⁻ is preferably an alkali salt, more preferably a Na⁺ and/or K⁺ salt.

56. (canceled)

57. (canceled)
